(19) United States
(12) Patent Application Publication
(10) Pub. No.: US 2024/0284517 A1
(43) Pub. Date: Aug. 22, 2024

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xinlei YU, Dongguan (CN); Haitao LI, Dongguan (CN); Yi HU, Dongguan (CN)

(73) Assignee: GUANGDONG OPPO MOBILE TELECOMMUNICATIONS CORP., LTD., Dongguan (CN)

(21) Appl. No.: 18/651,821

(22) Filed: May 1, 2024

Related U.S. Application Data
(63) Continuation of application No. PCT/CN2021/129918, filed on Nov. 10, 2021.

(51) Int. Cl. H04W 74/0833; H04W 72/232; H04W 74/0808

(52) U.S. Cl. CPC H04W 74/0833; H04W 72/232; H04W 74/0808

(57) ABSTRACT

A communication method, a terminal device, and a network device are disclosed. The method is applied to a terminal device, and includes: determining a starting moment offset according to an event triggering a random access procedure, wherein the starting moment offset is configured to delay starting monitoring a physical downlink control channel (PDCCH); receiving a message 4 (Msg 4) from a network device according to the starting moment offset, wherein the message 4 is contention resolution information, or the message 4 comprises the contention resolution information and a radio resource control (RRC) configuration message.

### CROSS REFERENCE TO RELATED APPLICATIONS

The present disclosure is a continuation of International Patent Application No. PCT/CN2021/129918, filed on Nov. 10, 2021, the contents of which is herein incorporated by reference in its entirety.

### TECHNICAL FIELD

The present disclosure relates to the field of communication, and in particular to a communication method, a terminal device, and a network device.

### BACKGROUND

In a random access procedure, a message 4 (Msg4) may include contention resolution information and may also include a radio resource control (RRC) configuration message. The contention resolution information is generated by a medium access control (MAC) layer and the RRC configuration message is generated by a RRC layer.

In a regenerative payload scenario of an access network device-distributed unit (e.g. a gNB-DU) carried in a satellite, since different random access procedure events correspond to different Msg4s, and there is a time difference between a moment at which a distributed unit (DU) carrying functions of the MAC layer generates the contention resolution information and a central unit (CU) carrying functions of the RRC layer generates the RRC configuration message, how to receive a corresponding Msg4 according to different random access procedure events is an urgent problem to be solved.

### SUMMARY

In a first aspect, the present disclosure provides a communication method, applied to a terminal device, including: determining a starting moment offset according to an event triggering a random access procedure, wherein the starting moment offset is configured to delay starting monitoring a physical downlink control channel (PDCCH); receiving a message 4 (Msg4) from a network device according to the starting moment offset, wherein the message 4 is contention resolution information, or the message 4 includes the contention resolution information and a radio resource control (RRC) configuration message.

In a second aspect, the present disclosure provides a terminal device, including: a transceiver; a memory, configured to store a computer executed instruction; and a processor, configured to perform the computer executed instruction stored in the memory, making the processor to perform the communication method of the first aspect.

In a third aspect, the present disclosure provides a network device, including: a transceiver; a memory, configured to store a computer executed instruction; and a processor, configured to perform the computer executed instruction stored in the memory, making the processor to perform: sending a message 4 (Msg4) to a terminal device according to an event triggering a random access procedure, wherein the message 4 is contention resolution information, or the message 4 comprises the contention resolution information and a radio resource control (RRC) configuration message.

### BRIEF DESCRIPTION OF THE DRAWINGS

FIG. 1 is a structural schematic view of a transparent payload satellite network architecture according to some embodiments of the present disclosure.

FIG. 2 is a first structural schematic view of a regenerative payload satellite network architecture according to some embodiments of the present disclosure.

FIG. 3 is a second structural schematic view of a regenerative payload satellite network architecture according to some embodiments of the present disclosure.

FIG. 4 is a schematic diagram of a control plane protocol stack according to some embodiments of the present disclosure.

FIG. 5 is a schematic flow chart of a four-step random access according to some embodiments of the present disclosure.

FIG. 6 is a schematic flow chart of a two-step random access according to some embodiments of the present disclosure.

FIG. 7 is a schematic diagram of a contention-based two-step random access according to some embodiments of the present disclosure.

FIG. 8 is a schematic diagram of a fallback from two-step random access to four-step random access according to some embodiments of the present disclosure.

FIG. 9 is a schematic diagram of a non-contention-based two-step random access according to some embodiments of the present disclosure.

FIG. 10 is a schematic flow chart of a communication method according to some embodiments of the present disclosure.

FIG. 11 is a first schematic diagram of receiving a Msg4 according to some embodiments of the present disclosure.

FIG. 12 is a second schematic diagram of receiving a Msg4 according to some embodiments of the present disclosure.

FIG. 13 is a third schematic diagram of receiving a Msg4 according to some embodiments of the present disclosure.

FIG. 14 is a fourth schematic diagram of receiving a Msg4 according to some embodiments of the present disclosure.

FIG. 15 is a fifth schematic diagram of receiving a Msg4 according to some embodiments of the present disclosure.

FIG. 16 is a sixth schematic diagram of receiving a Msg4 according to some embodiments of the present disclosure.

FIG. 17 is a seventh schematic diagram of receiving a Msg4 according to some embodiments of the present disclosure.

FIG. 18 is an eighth schematic diagram of receiving a Msg4 according to some embodiments of the present disclosure.

FIG. 19 is a structural schematic view of a communication apparatus according to some embodiments of the present disclosure.

FIG. 20 is a structural schematic view of a communication apparatus according to some embodiments of the present disclosure.

FIG. 21 is a structural schematic view of a terminal device according to some embodiments of the present disclosure.

FIG. 22 is a structural schematic view of a network device according to some embodiments of the present disclosure.

### DETAILED DESCRIPTION

In order to better understand the technical solutions of the present disclosure, related concepts and related technologies involved in the present disclosure will be described below.

A terminal device, which generally has a radio transceiver function, may be deployed on land, including indoor or outdoor, handheld, and wearable or vehicle-mounted; may also be deployed on water (e.g., ships); and still may be deployed in the air (such as aircraft, balloons, satellites, etc.). The terminal device may be a mobile phone, a pad, a computer with wireless transceiver function, a virtual reality (VR) terminal device, an augmented reality (AR) terminal device, a wireless terminal of industrial control, a vehicle-mounted terminal device, a wireless terminal of self-driving, a wireless terminal device of remote medical, a wireless terminal device of smart grid, a wireless terminal device of transportation safety, a wireless terminal device in smart city, a wireless terminal device in smart home, or a wearable terminal device. The terminal device in embodiments of the present disclosure may also be referred to as a terminal, user equipment (UE), access terminal device, vehicle-mounted terminal, industrial control terminal, UE unit, UE station, mobile station, remote station, remote terminal device, mobile device, UE terminal device, wireless communication device, and UE proxy or UE apparatus. The terminal device may also be fixed or mobile.

A network device generally has a radio transceiver function. The network device may have mobile characteristics, for example, the network device may be a mobile device. Optionally, the network device may be a communication satellite or a balloon station. For example, communication satellites may be classified into low earth orbit (LEO) satellites, medium earth orbit (MEO) satellites, geostationary earth orbit (GEO) satellites, and high elliptical orbit (HEO) satellites, according to different orbit altitudes. For example, orbital altitude of the LEO satellite ranges from 500 km to 1500 km with an orbital period (that is an orbital period around the Earth) of approximately 1.5 hours to 2 hours. A signal propagation delay of single-hop communication between users is about 20 ms, and a single-hop communication delay between users refers to a transmission delay from the terminal device to the network device, or a delay from the network device to a transmission device. Maximum visible time of the satellite is about 20 minutes. The maximum visible time refers to the longest time that beams of the satellite cover a certain area on the ground. The LEO satellite moves relative to the ground, and areas on the ground covered by the LEO satellite changes as the LEO satellite moves. The LEO satellite has short signal propagation distance and low link losses, and requirement for transmission power of the terminal device is low. Orbital altitude of the GEO satellite is generally 35786 km with an orbital period of 24 hours. A signal propagation delay of single-hop communication between users is about 250 ms. In order to ensure coverage of the satellite and improve system capacity of a communication network, the satellite can cover the ground with multiple beams. For example, one satellite can form dozens or hundreds of beams to cover the ground, and one beam can cover a ground area with a diameter of dozens to hundreds of kilometers. The network device may also be a base station set on land or in water. For example, the network device may be a next generation NodeB (gNB) or a next generation-evolved NodeB (ng-eNB). The gNB provides user plane functions and control plane functions of new radio (NR) for the UE, and the ng-eNB provides user plane functions and control plane functions of the evolved universal terrestrial radio access (E-UTRA) for the UE. It should be noted that the gNB and the ng-eNB are only names configured to indicate base stations supporting a 5G network system, and have no limiting significance. The network device may also be a base transceiver station (BTS) in a global system for mobile communications (GSM) or a code division multiple access (CDMA) system, a nodeB (NB) in a wideband code division multiple access (WCDMA) system, or an evolutional nodeB (eNB or eNodeB) in an long term evolution (LTE) system. Alternatively, the network device may also be a relay station, an access point, a vehicle-mounted device, a wearable device, and a network side device in a network after 5G or a network device or a road site unit (RSU) in a PLMN network of future evolution.

A non terrestrial network is abbreviated as an NTN. NTN technology generally uses satellite communication to provide communication services to the terminal device on the ground. Compared with terrestrial cellular network communication, the satellite communication has many unique advantages. First of all, the satellite communication is not limited by geographical areas. For example, areas where communication devices cannot be installed or where communication coverage is not available due to sparse population such as oceans, mountains, and deserts cannot be covered by normal land communication. For the satellite communication, because one satellite can cover a large ground and the satellite can orbit around the earth, so every ground of the earth can be covered by the satellite communication theoretically. Secondly, the satellite communication has a greater social value. The satellite communication can cover remote mountainous areas and poor and backward countries or regions at low cost, so that users in these areas can benefit from advanced voice communication and mobile Internet technology, which is conducive to narrowing the digital gap with developed areas and promoting the development of these areas. Thirdly, a distance of the satellite communication is long, and the communication cost does not increase significantly with the increase of a communication distance. Finally, stability of the satellite communication is high, and it is not limited by natural disasters. In order to ensure coverage of the satellite and enhance the system capacity of the entire satellite communication system, the satellite uses multi-beams to cover the ground. One satellite can form dozens or even hundreds of beams to cover the ground, and one satellite beam can cover a ground area with a diameter of dozens to hundreds of kilometers.

In a RRC state, the terminal device and the network device communicate and exchange information with each other through radio channels. Therefore, a control mechanism is needed to exchange information and reach agreement between the terminal device and the network device. This control mechanism is the RRC. In LTE, RRC states include a RRC idle state (RRC_IDLE) and a RRC connected state (RRC_INACTIVE). In 5G NR, besides the RRC idle state and the RRC connected state, a RRC inactive state (RRC_INACTIVE) is also introduced. In the RRC inactive state, the terminal device and the network device are in a non-connected state, but portion of context of the terminal device is still retained; meanwhile, the terminal device can quickly switch to the RRC connected state through a paging message.

For RRC_IDLE, mobility is UE-based cell select reselcetion, paging is initiated by a CN, and a paging area is configured by the CN. There is no UE AS context at a base station side and there is no RRC connection.

For RRC_CONNECTED, there exists a RRC connection and the UE AS context exists in the base station and the UE. A network side knows that a location of the UE is at a cell-specific level. Mobility is that controlled by the network side. Unicast data may be transmitted between the UE and the base station.

For RRC_INACTIVE, mobility is UE-based cell select reselection, there exists connection betweenCN-NR, the UE AS context exists on a certain base station, paging is triggered by a RAN, a RAN-based paging area is managed by the RAN, and the network side knows that the location of the UE is at a RAN-based paging area level.

RTT, which refers to a round-trip time.

GNSS, which refers to global navigation satellite system.

A random access refers to a process before the terminal device transmits a random access preamble to establish a basic signaling connection with the network device, and refers to a process in which the terminal device establishes a radio link with the network device and obtains or recovers uplink synchronization. The random access is a key step in a mobile communication system, making it possible for the terminal device and the network device to establish communication connection. The terminal device can exchange information with the network device through the random access, and can also realize uplink synchronization through the random access. In actual application processes, the terminal device may initiate the random access in a plurality of possible scenarios. For example, the plurality of possible scenarios may include at least one of scenarios: 1) the terminal device initiates the random access when establishing the radio link with the network device, after a state of the terminal device is switched from the radio resource control (RRC) idle state to the RRC connected state; 2) the terminal device initiates the random access when reestablishing the RRC connection with the network device, after the radio link between the terminal device and the network device fails; 3) the terminal device initiates the random access when needing to establish uplink synchronization with a new cell; 4) when the terminal device is in the RRC connected state and uplink is not synchronized, if uplink data or downlink data arrives, the random access is initiated; 5) the terminal device is in the RRC connected state, and when uplink data arrives, the terminal device initiates the random access when there is no physical uplink control channel (PUCCH) resource for sending a scheduling request; 6) the random access is initiated when the scheduling request fails; 7) the random access is initiated when a RRC request appears upon synchronous reconfiguration; 8) the random access is initiated when the state of the terminal device is switched from the RRC inactive state to the RRC connected state; 9) the random access is initiated when time alignment is established when a second cell is added; 10) the random access is initiated when requesting system information other than a master information block (MIB) and a system information block (SIB); 11) the random access is initiated when the beam fails to be recovered.

After introducing the basic concepts of the present disclosure, the background of the present disclosure will be introduced below.

Satellite network architectures include a transparent payload satellite network architecture and a regenerative payload satellite network architecture.

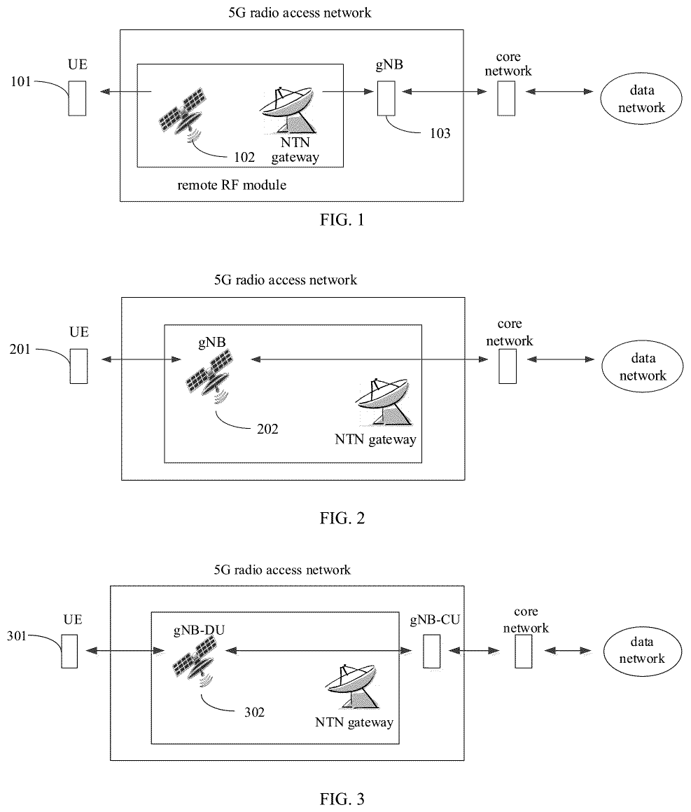

FIG. 1 is a structural schematic view of a transparent payload satellite network architecture according to some embodiments of the present disclosure. As shown in FIG. 1, the transparent payload satellite network architecture includes a terminal device 101, a satellite 102, and a base station 103. Wireless communication may be performed between the terminal device 101 and the satellite 102 wirelessly, and the satellite 102 can communicate with the base station 103. A network formed among the terminal device 101, the satellite 102, and the base station 103 may also be referred to as the NTN. In the architecture of a communication system shown in FIG. 1, the satellite 102 does not have functions of a base station (such as the gNB), communication between the terminal device 101 and the base station 103 needs to be relayed through the satellite 102, and the base station 103 is connected to a data network through a core network. In this system architecture, the base station 103 may be referred to as a network device, and the satellite 102 is a relay device between the terminal device 101 and the base station 103.

FIG. 2 is a first structural schematic view of a regenerative payload satellite network architecture according to some embodiments of the present disclosure. As shown in FIG. 2, the regenerative payload satellite network architecture includes a terminal device 201 and a satellite 202, and the terminal device 201 can communicate with the satellite 202 wirelessly. A network formed between the terminal device 201 and the satellite 202 may also be referred to as the NTN. In architecture of a communication system shown in FIG. 2, the satellite 202 has functions of a base station (such as the gNB), the terminal device 201 can communicate with the satellite 202 directly, and the satellite 202 is connected to a data network through a core network. In this system architecture, the satellite 202 may be referred to as a network device.

For the regenerative payload satellite network architecture, according to different functions carried in the satellite, three architectures are considered in 3GPP, such as gNB bearer, gNB-DU bearer, and integrated access and backhaul (IAB) as shown in FIG. 2. An architecture for carrying a gNB-DU in the satellite will be described below in conjunction with FIG. 3.

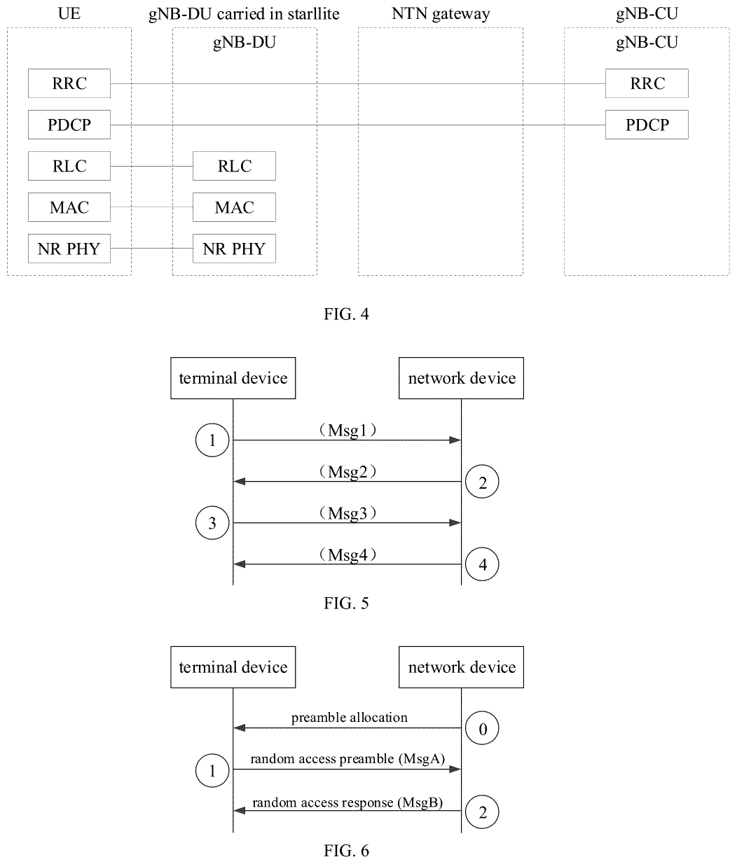

FIG. 3 is a second structural schematic view of a regenerative payload satellite network architecture according to some embodiments of the present disclosure. As shown in FIG. 3, the regenerative payload satellite network architecture includes a terminal device 301 and a satellite 302, the satellite 302 is configured to carry functions of the gNB-DU, and a gNB-CU is connected to a data network through a core network. For the network architecture as shown in FIG. 3, a control plane protocol stack of the terminal device will be described below in conjunction with FIG. 4.

FIG. 4 is a schematic diagram of a control plane protocol stack according to some embodiments of the present disclosure. As shown in FIG. 4, an example is the control plane protocol stack of the terminal device in the architecture for carrying the gNB-DU in the satellite (some structures are simplified in FIG. 4).

As shown in FIG. 4, functions of a physical layer (PHY), a medium access control (MAC), and a radio link control (RLC) layer are terminated on the gNB-DU carried in the satellite, and functions of a packet data convergence protocol (PDCP) and a RRC layer are terminated on a gNB-CU located on the ground. Compared with functions of the PHY, the MAC and the RLC processed on the gNB-DU, since the functions of the PDCP and the RRC are processed on the gNB-CU, there is additionally a delay of a feeder link between the satellite and a NTN gateway (generally located on the ground). In scenarios with an inter-satellite link (ISL), there also include a delay of a one-hop or a multi-hop inter-satellite link. Thus, the RRC functions are subject to stricter time constraints.

In the above embodiments, the satellite network architecture is introduced, and the random access procedure will be introduced below.

FIG. 5 is a schematic flow chart of a four-step random access according to some embodiments of the present disclosure. As shown in FIG. 5, the four-step random access may include the following.

### 1. The Terminal Device Sends a Msg1 to the Network Device.

The Msg1 may also be referred to as message 1, msg1, or MSG1. The Msg1 is configured to transmit a random access preamble, and the random access preamble may also be referred to as random access preamble sequence, or preamble, or preamble sequence.

In some embodiments, the terminal device may select PRACH resources and one preamble, and transmits the selected preamble on the selected PRACH resources.

### 2. The Network Device Sends a Msg2 to the Terminal Device.

The Msg2 may also be referred to as message 2, msg2, or MSG2. The Msg2 includes a time-frequency resource which is used to transmit payload and is determined by the network device for the terminal device. After sending the Msg1, the terminal device may start a random access response time window (ra-Response Window), and monitors a physical downlink control channel (PDCCH) scrambled by a random access radio network temporary identifier (RA-RNTI) within the random access response time window.

After the terminal device successfully receives the PDCCH scrambled by the RA-RNTI, the terminal device can obtain a physical downlink shared channel (PDSCH) scheduled by the PDCCH, which includes a random access response (RAR). The RAR may include the following information.

A back-off indicator (BI) included in a subheader of the RAR, which is configured to indicate back-off time of retransmission of the Msg1; a RAPID of the RAR which represents a preamble index received in a network response; a timing advance group (TAG) included in a payload of the RAR, which is configured to adjust uplink timing; an uplink grant which represents an uplink resource indication configured to schedule the Msg3; and a temporary cell radio network temporary identifier (C-RNTI) which is used for a PDCCH configured to scramble the Msg4. If the terminal device receives the PDCCH scrambled by the RA-RNTI, and the RAR includes the preamble index transmitted by the terminal device, the terminal device considers that the random access response is successfully received.

### 3. The Terminal Device Sends a Msg3 to the Network Device.

The Msg3 may also be referred to as message 3, msg3, or MSG3. The Msg3 is the first scheduled transmission in the random access procedure, configured to transmit a payload such as a RRC connection request, a tracking area update message, etc. The Msg3 may inform the network device what event triggers the random access channel (RACH) procedure. For example, if it is an initial random access procedure, a UE ID and an establishment cause are carried; if it is a RRC reestablishment, a identifier of a UE in the connected state and the establishment cause are carried. It should be noted that, if different terminal devices select the same preamble and transmit the preamble on the same time-frequency resource, the different terminal devices transmit the payload on the same time-frequency resource, thereby causing resource usage conflict.

### 4. The Network Device Sends a Msg4 to the Terminal Device.

The Msg4 may also be referred to as message 4, msg4, or MSG4, and is configured to indicate whether the terminal device successfully accesses the network device.

After sending the Msg3, the terminal device starts a contention resolution timer (ra-ContentionResolutionTimer), and the terminal device monitors the PDCCH to receive the Msg4 during a running period of the contention resolution timer.

The Msg4 may have the following two functions: 1) on contention resolution (i.e., through the contention resolution information); and 2) on which the network device transmits the RRC configuration message to the terminal device. There are two ways for contention resolution: 1) if the terminal device carries the C-RNTI in the Msg3, the contention resolution information is scheduled by the PDCCH scrambled by the C-RNTI, and 2) if the terminal device does not carry the C-RNTI in the Msg3, the contention resolution information is scheduled by the PDCCH scrambled by the TC-RNTI, for example, when being in an initial access. The contention resolution is that the terminal device receives a PDSCH of the contention resolution information, and matches a common control channel (CCCH) service data unit (SDU) in the PDSCH.

FIG. 6 is a schematic flow chart of a two-step random access according to some embodiments of the present disclosure. As shown in FIG. 6, the two-step random access may include the following.

### 1. The Terminal Device Sends a MsgA to the Network Device.

The MsgA may also be referred to as msgA or MSGA. The MsgA includes a preamble and a payload (such as the RRC connection request message, the tracking area update message, etc.). Before sending the MsgA, the network device may perform preamble allocation.

2. The Network Device Sends a msgB to the Terminal Device.

The msgB may also be referred to as MsgB or MSGB, and is configured to indicate whether the terminal device successfully accesses the network device.

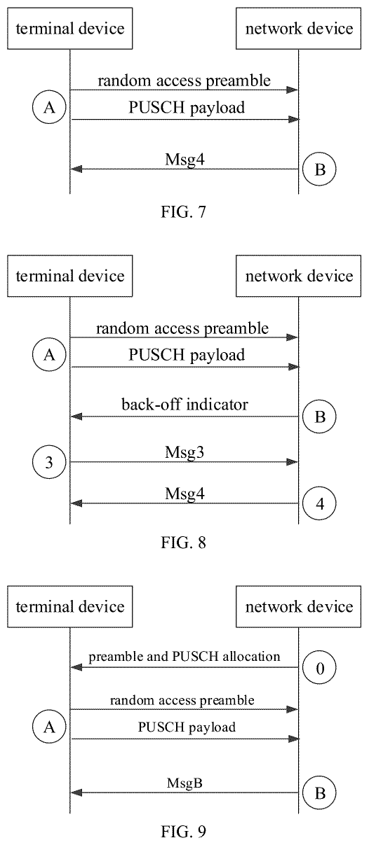

The two-step random access procedure is introduced into NR Rel-16 to reduce latency and signaling overhead. The MsgA in the two-step random access includes a preamble transmitted in the PRACH and payload information transmitted in the PUSCH. FIG. 7 is a schematic diagram of a contention-based two-step random access according to some embodiments of the present disclosure. As shown in FIG. 7, after transmitting a random access preamble (such as the MsgA), the terminal device monitors a response from the network device side within a configured window. If a contention resolution success indication (i.e., the contention resolution information or the Msg4) sent by the network device is received, the terminal device ends the random access procedure.

FIG. 8 is a schematic diagram of a fallback from two-step random access to four-step random access according to some embodiments of the present disclosure. As shown in FIG. 8, the terminal device transmits the Msg3 and monitors a contention resolution result if a back-off indicator is received in the MsgB. The terminal device continues to transmit the MsgA if contention resolution unsuccess after transmitting the Msg3.

FIG. 9 is a schematic diagram of a non-contention-based two-step random access according to some embodiments of the present disclosure. As shown in FIG. 9, the terminal device receives the random access response from the network device to complete the random access procedure after transmitting the random access preamble (the MsgA).

After the two-step random access is introduced, if the network device is configured with a MsgA resource for the two-step random access and a RACH resource for the four-step random access at the same time, for a contention-based random access, the terminal device will first select a random access type before performing the random access. A conclusion of NR standardization at present is that the terminal device selects the random access type based on reference signal receiving power (RSRP) measurement. When the RSRP measured by the terminal device is higher than a RSRP threshold configured by the network device, the terminal device uses the two-step random access; otherwise, the terminal device uses the four-step random access.

After sending the Msg3, the terminal device starts the contention resolution timer (ra-ContentionRosolutionTimer) and monitors the PDCCH to receive the Msg4 during the period. The Msg4 may include contention resolution information, and the contention resolution information is configured for contention resolution and generated by the MAC layer. The Msg4 may also include a RRC configuration message generated by the RRC layer. In embodiments of the present disclosure, the Msg4 includes the contention resolution information and the RRC configuration message, meaning that when transmission of the RRC configuration message is involved, the contention resolution information and the RRC configuration message are collectively referred to as the Msg4, but not meaning that the contention resolution information and the RRC configuration message are transmitted in a same transmission block (TB) when being mapped to the time-frequency resource from the physical layer. In RRC connection establishment/recovery and reestablishment procedures, the terminal device supports the contention resolution information for contention resolution and the RRC configuration message being transmitted in different TBs, or supports the contention resolution information and the RRC configuration message being transmitted in the same TB.

In a transparent payload scenario carried in the satellite, aiming at the problem of long latency from the terminal device to the gNB in a cell, an offset is introduced for the random access response time windows (ra-ResponseWindow and msgB-ResponseWindow) of the Msg2 or the MsgB received by the terminal device during the random access procedure, and for the contention resolution timer (ra-ContentionResolutionTimer) of the Msg4 received by the terminal device during the four-step random access procedure. The timer and the time windows are started after the offset. The offset uses a RTT from the UE to the gNB.

In a regenerative payload scenario of an access network device-distributed unit (gNB-DU) carried in the satellite, since different random access procedure events correspond to different Msg4s, and there is a time difference between a moment at which a DU carrying functions of the MAC layer generates the contention resolution information and a moment at which a CU carrying functions of the RRC layer generates the RRC configuration message, how to receive a corresponding Msg4 according to different random access procedure events is an urgent problem to be solved.

The embodiments of the present disclosure provide a communication method to realize reception of the Msg4 in the regenerative payload scenario of the gNB-DU carried in the satellite. The scheme of the present disclosure will be described below in conjunction with the drawings.

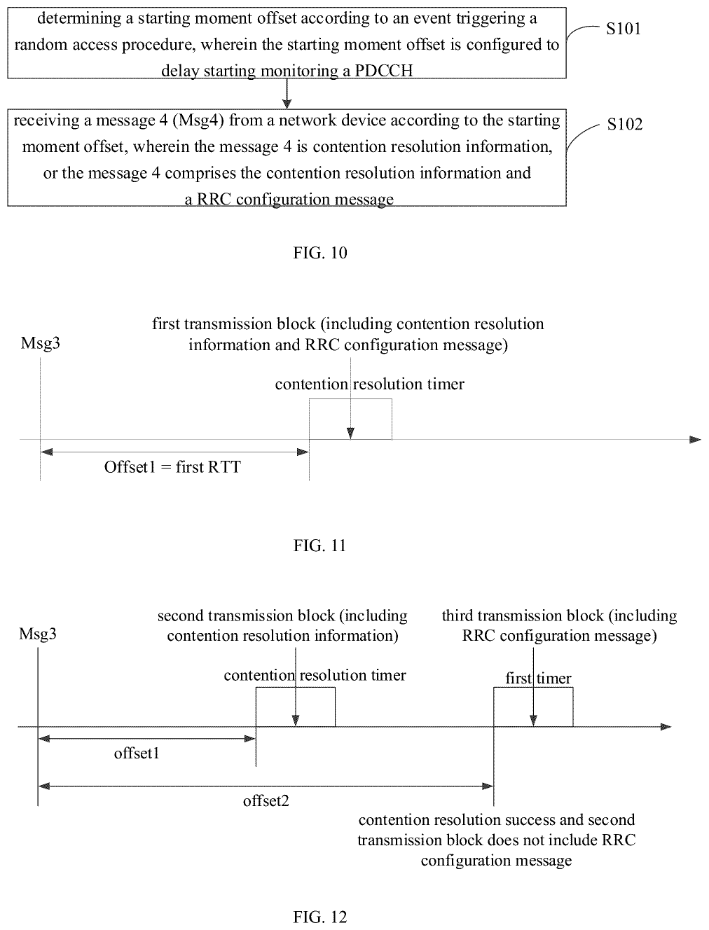

FIG. 10 is a schematic flow chart of a communication method according to some embodiments of the present disclosure. As shown in FIG. 10, the method may include operations in the following.

At block 101, a starting moment offset is determined according to an event triggering a random access procedure, wherein the starting moment offset is configured to delay starting monitoring a PDCCH.

In the regenerative payload scenario of the gNB-DU carried in the satellite, during a contention-based random access procedure, the terminal device may configure the starting moment offset for delaying starting monitoring the PDCCH according to the event triggering the random access procedure. Since there are different events triggering the random access procedure, and the messages 4 may also be different, configured starting moment offsets may also be different. For example, for some random access procedure events, the message 4 is the contention resolution information, and the starting moment offset is a first starting moment offset configured to delay starting a contention resolution timer. For other random access procedure events, the message 4 may include the contention resolution information and the RRC configuration message, and the starting moment offsets may include the first starting moment offset configured to delay starting the contention resolution timer and may further include a second starting moment offset configured to delay starting monitoring the PDCCH to receive the RRC configuration message.

At block 102, a message 4 (Msg4) is received from the network device according to the starting moment offset. The message 4 is the contention resolution information, or the message 4 includes the contention resolution information and the RRC configuration message.

After configuring the starting moment offset according to the event triggering the random access procedure, starting monitoring the PDCCH is delayed according to the starting moment offset and the message 4 is received from the network device. For example, when the message 4 is the contention resolution information, the terminal device can delay starting the contention resolution timer according to the first starting moment offset, and monitor the PDCCH during a period of the contention resolution timer to obtain the contention resolution information. When the message 4 includes the contention resolution information and the RRC configuration message, monitoring the PDCCH is delayed according to the starting moment offset configured, and the contention resolution information and the RRC configuration message are obtained.

The embodiments of the present disclosure provide the communication method, in which the terminal device determines the starting moment offset according to the event triggering the random access procedure, and receives the message 4 from the network device according to the starting moment offset. Since different random access procedure events correspond to different messages 4, the embodiments of the present disclosure configure the starting moment offset for delaying starting monitoring the PDCCH according to the event triggering the random access procedure, thereby realizing reception of the message 4 in the regenerative payload scenario of the gNB-DU carried in the satellite.

In the regenerative payload scenario of the gNB-DU carried in the satellite, during performing the contention-based random access procedure, the terminal device configures the starting moment offset for delaying starting monitoring the PDCCH according to the event triggering the random access procedure.

The random access procedure events may include two categories, i.e., a first random access procedure event and a second random access procedure event. In embodiments of the present disclosure, the event triggering the random access procedure is the first random access procedure event or the second random access procedure event. The first random access procedure event is an event generating the RRC configuration message, and the second random access procedure event is another random access procedure event except for the first random access procedure event. That is, the first random access procedure event relates to transmission of the RRC configuration message, and the second random access procedure event does not relate to the transmission of the RRC configuration message.

As described in the above embodiments, the event triggering the random access procedure may include the following events.
(a) the terminal device triggers the random access procedure when the terminal device initially accesses. That is, after state of the terminal device is switched from the RRC idle state to the RRC connected state, the terminal device initiates the random access procedure when establishing a radio link procedure with the network device during the initial access.
(b) the terminal device triggers the random access procedure when the terminal device reestablishes a RRC connection. That is, after the radio link between the terminal device and the network device fails, the terminal device initiates the random access procedure when reestablishing the RRC connection with the network device.
(c) the terminal device triggers the random access procedure when the terminal device establishes uplink synchronization with a new cell. That is, when the terminal device is in the RRC connected state and uplink is not synchronized, the random access procedure is initiated if uplink or downlink data arrives.
(d) the terminal device triggers the random access procedure when the terminal device is in the RRC connected state and uplink data arrives, but dedicated resources for sending a scheduling request have not been configured for the terminal device on the PUCCH.
(e) the terminal device triggers the random access procedure when a scheduling request of the terminal device fails. That is, when the scheduling request of the terminal device fails, the random access procedure is initiated to obtain PUCCH resources again.
(f) the terminal device triggers the random access procedure when the terminal device requests a synchronization reconfiguration from RRC.
(g) the terminal device triggers the random access procedure when the terminal device restores the RRC connection, which belongs to an RRC connection restoring procedure. That is, when the state of the terminal device is switched from the RRC inactive state to the RRC connected state, the random access procedure is initiated.
(h) the terminal device triggers the random access procedure when the terminal device establishes time synchronization in a process of adding a secondary cell, or the terminal device initiates the random access procedure when the terminal device establishes time alignment when adding a second cell.
(i) the terminal device triggers the random access procedure when the terminal device requests other system information, and the random access procedure is triggered when other system information except for MIB and SIB is requested.
(j) the terminal device initiates the random access procedure when beams fail to be recovered.

In some embodiments, the first random access procedure events may include event (a), event (b) and event (g), which are events that the terminal device triggers the random access procedure when the terminal device initially accesses; that the terminal device triggers the random access procedure when the terminal device reestablishes a RRC connection; and that the terminal device triggers the random access procedure when the terminal device restores the RRC.

The second random access procedure event is another random access procedure event except for the first random access procedure event, for example, including event (c), event (d), event (e), event (f), event (h), event (i), and event j). That is, the second random access procedure event includes events that the terminal device triggers the random access procedure when the terminal device establishes uplink synchronization with a new cell; the terminal device triggers the random access procedure when the terminal device is in the RRC connected state and there is no PUCCH resource for sending a scheduling request when uplink data arrives; the terminal device triggers the random access procedure when a scheduling request of the terminal device fails; the terminal device triggers the random access procedure when the terminal device requests a synchronization reconfiguration from RRC; the terminal device triggers the random access procedure when the terminal device establishes time synchronization in a process of adding a secondary cell; the terminal device triggers the random access procedure when the terminal device requests other system information; the terminal device triggers the random access procedure when beams fail to be recovered.

Since the first random access procedure event is the event generating the RRC configuration message, and the second random access procedure event is the event not generating the RRC configuration message, the message 4 includes the contention resolution information configured to resolve contention and the RRC configuration message when the event triggering the random access procedure is the first random access procedure event; and the message 4 is the contention resolution information when the event triggering the random access procedure is the second random access procedure event.

For different random access procedure events, configuration of the starting moment offset is different. The starting moment offset may include a first RTT and/or a second RTT.

In some embodiments, before configuring the starting moment offset, the network device may send second information to the terminal device, and the second information include ephemeris information of the satellite associated with the terminal device and/or a third RTT from the DU to the CU. A first RTT from the terminal device to the CU and/or a second RTT from the terminal device to the DU is then obtained according to the second information and/or location information of the terminal device. In some embodiments, the second information is configured by a system message or RRC signaling.

The location information of the terminal device can be obtained by GNSS. A distance from the terminal device to the DU may be acquired according to the ephemeris information of the satellite associated with the terminal device and the location information of the terminal device. The second RTT from the terminal device to the DU may be then obtained according to the distance from the terminal device to the DU. The first RTT from the terminal device to the CU may be obtained according to the second RTT from the terminal device to the DU and the third RTT from the DU to the CU. The first RTT=the second RTT+the third RTT.

The following describes schemes in which the terminal device receives the message 4 when the message 4 includes the contention resolution information and the RRC configuration message, or when the message 4 is the contention resolution information.

When the event triggering the random access procedure is the first random access procedure event, the message 4 includes the contention resolution information and the RRC configuration message. For the first random access procedure event, the contention resolution information and the RRC configuration message are supported to be transmitted in different transmission blocks, and the contention resolution information and the RRC configuration message are also supported to be transmitted in a same transmission block.

In the regenerative payload scenario of the gNB-DU carried in the satellite, since the functions of the MAC layer are terminated on the gNB-DU carried in the satellite, and the functions of the RRC layer are terminated on the gNB-CU located on the ground, there is a feeder link offset between the MAC layer and the RRC layer, and there is even an one-hop or a multi-hop inter-satellite link offset (in scenarios with an inter-satellite link). Therefore, there is an inevitable time difference between generation of the contention resolution information and generation of the RRC configuration message. How to solve reception of the RRC configuration message in the regenerative payload scenario of the gNB-DU carried in the satellite is an urgent problem. If the gNG-DU generates a Msg4 not including the RRC configuration message and sends the Msg4 to the terminal device, the terminal device still needs to continuously monitor the PDCCH at least beyond the RTT from the DU to the CU to receive the RRC configuration message after the contention resolution timer ends. Continuous unnecessary monitoring is not conducive to energy saving of the terminal device.

In embodiments of the present disclosure, the terminal device needs to determine the starting moment offset according to a transmission relationship between the contention resolution information and the RRC configuration message. The transmission relationship represents the contention resolution information and the RRC configuration message being transmitted in a same transmission block, or the contention resolution information and the RRC configuration message being transmitted in different transmission blocks. The starting moment offset may be the first starting moment offset of the contention resolution timer, or the starting moment offset includes the first starting moment offset and the second starting moment offset.

In some embodiments, the terminal device obtains first information from the network device, and determines the transmission relationship according to the first information. That is, the network device indicates the transmission relationship to the terminal device before transmitting the message 4.

The starting moment offset is the first starting moment offset when the contention resolution information and the RRC configuration message are transmitted in the same transmission block. The first starting moment offset is configured to delay starting the contention resolution timer, and the first starting moment offset is the first RTT from the terminal device to the CU.

After finishing sending the Msg3, the terminal device starts the contention resolution timer after the first starting moment offset passes from the first symbol when transmission of the Msg3 ends, and restarts the contention resolution timer at each hybrid automatic repeat request (HARQ) retransmission.

FIG. 11 is a first schematic diagram of receiving a Msg4 according to some embodiments of the present disclosure. As shown in FIG. 11, an example is illustrated in which the contention resolution information and the RRC configuration message are transmitted in the same transmission block, and a corresponding event triggering the random access procedure is the first random access procedure event.

In the example, the starting moment offset is the first starting moment offset offset1. The offset1 is the first RTT. After finishing sending the Msg3, the terminal device starts the contention resolution timer after the offset1 passes from the first symbol when transmission of the Msg3 ends.

During a running period of the contention resolution timer, the terminal device may always monitor the PDCCH to obtain the first transmission block without considering possible measurement intervals. The first transmission block includes the contention resolution information and the RRC configuration message. In this case, the Msg4 including the contention resolution information and the RRC configuration message indicates that the contention resolution information and the RRC configuration message are located in a same TB when mapped to the time-frequency resource of the physical layer.

In the regenerative payload scenario of the gNB-DU carried in the satellite, since the functions of the MAC layer are terminated on the gNB-DU carried in the satellite, and the functions of the RRC layer are terminated on the gNB-CU located on the ground, there is a feeder link offset between them, and there is even an one-hop or a multi-hop inter-satellite link offset (in scenarios with an inter-satellite link). Therefore, there is an inevitable time difference between generation of the Msg4 and generation of the RRC configuration message. For the first random access procedure event, the first starting moment offset of the contention resolution timer is configured to be the first RTT from the terminal device to the gNB-CU. During the running period of the contention resolution timer, the gNB-DU can wait for the RRC configuration message and transmit the RRC configuration message and the contention resolution information simultaneously. By setting the contention resolution information and the RRC configuration message to be transmitted in the same TB, it is avoided that the terminal device continuously monitors the PDCCH of a RRT duration from the DU to the CU to receive the RRC configuration message after receiving the contention resolution information, reducing unnecessary PDCCH monitoring behavior and facilitating energy saving of the terminal device.

In above embodiments, the scheme is introduced in which the terminal device obtains the message 4 when the message 4 includes the contention resolution information and the RRC configuration message, and the contention resolution information and the RRC configuration message are transmitted in the same TB. A scheme in which the terminal device obtains the message 4 when the contention resolution information and the RRC configuration message are transmitted in different TBs will be described below. In this case, the Msg4 including the contention resolution information and the RRC configuration message indicates that the contention resolution information and the RRC configuration message are collectively referred to as the Msg4, but does not indicate that the contention resolution information and the RRC configuration message are located in the same TB when mapped to the time-frequency resource of the physical layer.

When the contention resolution information and the RRC configuration message are transmitted in different TBs, the starting moment offset includes the first starting moment offset and the second starting moment offset. The terminal device may receive the configuration information from the network device, and then determine the starting moment offset according to the configuration information. In some embodiments, the configuration information is configured by a system message or RRC signaling.

The configuration information includes an effective moment of the second starting moment offset, or the configuration information includes the effective moment of the second starting moment offset and configuration information of a first timer associated with the second starting moment offset. The effective moment of the second starting moment offset is configured to indicate a timing origin of the second starting moment offset.

The effective moment may be any one of a moment at which the transmission of the message 3 ends, a moment at which the contention resolution timer starts, and a moment at which the contention resolution information is received. After obtaining the effective moment of the second starting moment offset according to the configuration information, the terminal device may determine a value of the second starting moment offset offset2 according to the effective moment.

When the effective moment is the moment at which the transmission of the message 3 ends, the second starting moment offset is the first RTT. When the effective moment is the moment at which the contention resolution timer starts, the second starting moment offset is the third RTT from the DU to the CU. When the effective moment is the moment at which the contention resolution information is received, the second starting moment offset is a sum of a difference between the third RTT and a duration of the contention resolution timer and a current remaining duration of the contention resolution timer. When the effective moment is the moment at which the contention resolution information is received, the second starting moment offset is a duration indicated by the MAC CE. In some embodiments, the MAC CE is carried in the Msg2 or in the contention resolution information.

In response to the starting moment offset including the first starting moment offset and the second starting moment offset, the terminal device starts the contention resolution timer after the first starting moment offset passes from which the transmission of the Msg3 ends. During the running period of the contention resolution timer, the PDCCH is monitored and the second transmission block is obtained. The second transmission block includes the contention resolution information. That is, the contention resolution information is transmitted in the second transmission block.

According to the effective moment and the second starting moment offset obtained based on the configuration information, a third transmission block is then received from the network device. The third transmission block includes the RRC configuration message. That is, the RRC configuration message is transmitted in the third transmission block. The third transmission block is different from the second transmission block.

In response to the configuration information including the effective moment and the configuration information of the first timer, the terminal device can start the first timer after the second starting moment offset passes from the effective moment. During a running period of the first timer, the PDCCH is monitored and the third transmission block is obtained, realizing reception of the RRC configuration message. A duration of monitoring the PDCCH is less than or equal to a duration of the first timer.

The above schemes will be described separately below in conjunction with the drawings.

FIG. 12 is a second schematic diagram of receiving a Msg4 according to some embodiments of the present disclosure. As shown in FIG. 12, an example is illustrated, in which the configuration information includes the effective moment of the second starting moment offset and the configuration information of the first timer.

The terminal device receives the configuration information from the network device, and can obtain the effective moment of the second starting moment offset and the configuration information of the first timer according to the configuration information. Manners of obtaining the configuration information may include a dedicated signaling, system messages (such as MIB, SIB1, SIB2, SIB3, SIB4, etc.) sent in a broadcast manner, etc. For example, the network device sends a first system message to the terminal device, and the first system message includes the configuration information. The terminal device can obtain the first system message from the network device and obtains the configuration information according to the first system message. The network device sends a first RRC signaling to the terminal device, and the first RRC signaling includes the configuration information. The terminal device can obtain the first RRC signaling from the network device and obtains the configuration information according to the first RRC signaling.

FIG. 12 illustrates that the effective moment of the second starting moment offset is determined to be the moment at which the transmission of the Msg3 ends according to the configuration information, and the second starting moment offset is configured to delay starting the first timer. In some embodiments, the configuration information of the first timer may include a first duration or may not include the first duration. In response to the configuration information of the first timer including the first duration, a duration of the first timer is the first duration. In response to the configuration information of the first timer not including the first duration, the duration of the first timer is a duration of the contention resolution timer by default.

The terminal device can receive the second information from the network device, the second information includes the ephemeris information of the satellite associated with the terminal device and/or the third RTT from the DU to the CU. The first RTT from the terminal device to the CU and/or the second RTT from the terminal device to the DU is obtained according to the second information and/or the location information of the terminal device. In some embodiments, the network device can send a second system message to the terminal device, and the second system message includes the second information. The terminal device receives the second system message from the network device and obtains the second information according to the second system message. In some embodiments, the network device can send a second RRC signaling to the terminal device, and the second RRC signaling includes the second information. The terminal device receives the second RRC signaling from the network device and obtains the second information according to the second RRC signaling.

After the second RTT is obtained, the first starting moment offset offset1 can be configured according to the second RTT. The first starting moment offset offset1 is the second RTT from the terminal device to the DU.

The terminal device starts the contention resolution timer after the first starting moment offset offset1 passes from the first symbol after the transmission of the Msg3 ends and restarts the contention resolution timer at each HARQ retransmission.

In some embodiments, during the running period of the contention resolution timer, the terminal device may always monitor the PDCCH to obtain the second transmission block without considering possible measurement intervals. The second transmission block includes the contention resolution information, so as to realize the reception of the contention resolution information.

During the running period of the contention resolution timer, if a notification of PDCCH transmission of a SpCell is received from a lower layer, it may be further known whether contention resolution successes.

In some embodiments, if the Msg3 includes a C-RNTI MAC CE, the contention resolution information uses a PDCCH scheduling scrambled by the C-RNTI. If the terminal device receives the PDCCH scheduling scrambled by the C-RNTI and a corresponding PDSCH, it indicates the contention resolution success.

In some embodiments, if the Msg3 does not include the C-RNTI but include the CCCH SDU, the contention resolution information uses a PDCCH scheduling scrambled by a TC-RNTI. When a MAC PDU is successfully decoded, the contention resolution timer is stopped. When the terminal device receives the PDSCH of the contention resolution information and determines the contention resolution success by matching a terminal device contention resolution identifier MAC CE in the contention resolution information with the CCCH SDU in the Msg3, it indicates the contention resolution success.

In response to the contention resolution timer being time out, the TC-RNTI is discarded, which indicates contention resolution unsuccess.

After obtaining the first RTT, the terminal device configures the second starting moment offset offset2 according to the first RTT and the effective moment of the second starting moment offset. As shown in FIG. 12, the offset2 is the first RTT.

The terminal device determines whether to start the first timer after the second starting moment offset offset2 passes from the first symbol after the transmission of the Msg3 ends.

When it is the contention resolution success, and the second transmission block includes the RRC configuration message, the terminal device does not start the first timer.

When it is the contention resolution success and the second transmission block does not include the RRC configuration message, the terminal device starts the first timer. During the running period of the first timer, the terminal device monitors the PDCCH and obtains the third transmission block, and the third transmission block includes the RRC configuration message. The duration of monitoring the PDCCH is less than or equal to the duration of the first timer.

In some embodiments, during the running period of the first timer, the terminal device may always monitor the PDCCH without considering possible measurement intervals.

During the running period of the first timer, if the notification of PDCCH transmission of the SpCell is received from the lower layer and the PDSCH scheduled by the PDCCH includes the RRC configuration message, the RRC configuration message is delivered to an upper layer and the first timer is stopped. In this case, it is considered that the terminal device successfully receives the RRC configuration message.

Failure of receiving the RRC configuration message is reported to the upper layer, in response to the first timer being time out. In this case, it is considered that the terminal device fails to receive the RRC configuration message.

In regenerative payload scenario of the gNB-DU carried in the satellite, since the functions of the MAC layer are terminated on the gNB-DU carried in the satellite and the functions of the RRC layer are terminated on the gNB-CU located on the ground, there is the feeder link offset between them, and there is even the one-hop or the multi-hop inter-satellite link offset (in scenarios with the inter-satellite link). Therefore, there is the inevitable time difference between generation of the contention resolution information and generation of the RRC configuration message. In embodiments of the present disclosure, the terminal device further adds the first timer configured to receive the RRC configuration message sent separately in addition to starting the contention resolution timer, and configures the first starting moment offset for delaying starting the contention resolution timer and the second starting moment offset for delaying starting the first timer. The effective moment of the second starting moment offset is the moment at which the transmission of the Msg3 ends. The PDCCH is monitored to receive the contention resolution information during the running period of the contention resolution timer, and the PDCCH scrambled by the C-RNTI is monitored to receive the RRC configuration message during the running period of the first timer. For the case where the contention resolution information and the RRC configuration message are transmitted in different TBs, the PDCCH may be monitored at an appropriate time to receive the RRC configuration message sent separately, and there is no need to continuously monitor the PDCCH after receiving the contention resolution information, thereby reducing unnecessary energy overhead of the terminal device and facilitating energy saving of the terminal device.

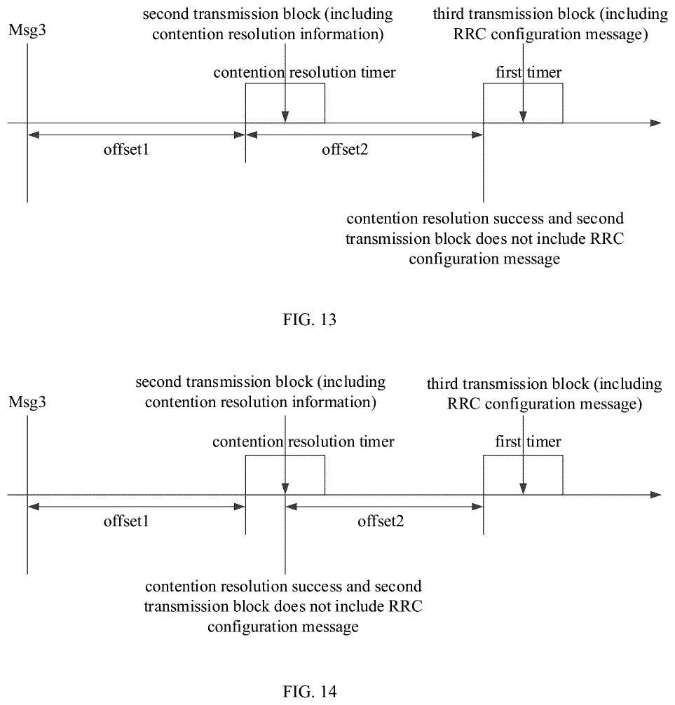

FIG. 13 is a third schematic diagram of receiving a Msg4 according to some embodiments of the present disclosure. As shown in FIG. 13, an example is illustrated, in which the configuration information includes the effective moment of the second starting moment offset and the configuration information of the first timer.

The terminal device receives the configuration information from the network device, and can obtain the effective moment of the second starting moment offset and the configuration information of the first timer according to the configuration information. Manners of obtaining the configuration information may include a dedicated signaling, system messages (such as MIB, SIB1, SIB2, SIB3, SIB4, etc.) sent in the broadcast manner, etc. For example, the network device sends the first system message to the terminal device, and the first system message includes the configuration information. The terminal device can obtain the first system message from the network device and obtains the configuration information according to the first system message. The network device sends a first RRC signaling to the terminal device, and the first RRC signaling includes the configuration information. The terminal device can obtain the first RRC signaling from the network device and obtains the configuration information according to the first RRC signaling.

FIG. 13 illustrates that the effective moment of the second starting moment offset is determined to be a moment at which the contention resolution timer starts according to the configuration information, and the second starting moment offset is configured to delay starting the first timer. In some embodiments, the configuration information of the first timer may include the first duration or may not include the first duration. When the configuration information of the first timer includes the first duration, the duration of the first timer is the first duration. When the configuration information of the first timer does not include the first duration, the duration of the first timer is the duration of the contention resolution timer by default.

The terminal device can receive the second information from the network device, the second information includes the ephemeris information of the satellite associated with the terminal device and/or the third RTT from the DU to the CU. The first RTT from the terminal device to the CU and/or the second RTT from the terminal device to the DU is obtained according to the second information and/or the location information of the terminal device. In some embodiments, the network device can send the second system message to the terminal device, and the second system message includes the second information. The terminal device receives the second system message from the network device and obtains the second information according to the second system message. In some embodiments, the network device can send the second RRC signaling to the terminal device, and the second RRC signaling includes the second information. The terminal device receives the second RRC signaling from the network device and obtains the second information according to the second RRC signaling.

After the second RTT is obtained, the first starting moment offset offset1 can be configured according to the second RTT. The first starting moment offset offset1 is the second RTT from the terminal device to the DU.

The terminal device starts the contention resolution timer after the first starting moment offset offset1 passes from the first symbol after the transmission of the Msg3 ends, and restarts the contention resolution timer at each HARQ retransmission.

In some embodiments, during the running period of the contention resolution timer, the terminal device may always monitor the PDCCH to obtain the second transmission block without considering possible measurement intervals. The second transmission block includes the contention resolution information, so as to realize the reception of the contention resolution information.

During the running period of the contention resolution timer, if a notification of PDCCH transmission of a SpCell is received from a lower layer, it may be further known whether it is a contention resolution success.

In some embodiments, the contention resolution information uses the PDCCH scheduling scrambled by the C-RNTI if the Msg3 includes the C-RNTI MAC CE. If the terminal device receives the PDCCH scheduling scrambled by the C-RNTI and the corresponding PDSCH, it indicates the contention resolution success.

In some embodiments, if the Msg3 does not include the C-RNTI but include the CCCH SDU, the contention resolution information uses the PDCCH scheduling scrambled by the TC-RNTI. When the MAC PDU is successfully decoded, the contention resolution timer is stopped. When the terminal device receives the PDSCH of the contention resolution information and determines the contention resolution success by matching a terminal device contention resolution identifier MAC CE in the contention resolution information with the CCCH SDU in the Msg3, it indicates the contention resolution success.

In response to the contention resolution timer being time out, the TC-RNTI is discarded, which indicates contention resolution unsuccess.

After obtaining the first RTT, the terminal device configures the second starting moment offset offset2 according to the first RTT and the effective moment of the second starting moment offset. As shown in FIG. 13, the offset2 is the third RTT from the DU to the CU.

The terminal device determines whether to start the first timer after the second starting moment offset offset2 passes from a moment at which the contention resolution timer starts.

When it is the contention resolution success, and the second transmission block includes the RRC configuration message, the terminal device does not start the first timer.

When it is the contention resolution success, and the Msg4 of the second transmission block does not include the RRC configuration message, the terminal device starts the first timer. During the running period of the first timer, the terminal device monitors the PDCCH and obtains the third transmission block, and the third transmission block includes the RRC configuration message. The duration of monitoring the PDCCH is less than or equal to the duration of the first timer.

In some embodiments, during the running period of the first timer, the terminal device may always monitor the PDCCH without considering possible measurement intervals.

During the running period of the first timer, if the notification of PDCCH transmission of the SpCell is received from the lower layer and the PDSCH scheduled by the PDCCH includes the RRC configuration message, the RRC configuration message is delivered to the upper layer and the first timer is stopped. In this case, it is considered that the terminal device successfully receives the RRC configuration message.

Failure of receiving the RRC configuration message is reported to the upper layer in response to the first timer being time out. In this case, it is considered that the terminal device fails to receive the RRC configuration message.

In embodiments of the present disclosure, the terminal device further adds the first timer configured to receive the RRC configuration message sent separately in addition to starting the contention resolution timer, and configures the first starting moment offset for delaying starting the contention resolution timer and the second starting moment offset for delaying starting the first timer. The effective moment of the second starting moment offset is the moment at which the contention resolution timer starts. The PDCCH is monitored to receive the contention resolution information during the running period of the contention resolution timer, and the terminal device continuously monitors the PDCCH scrambled by the C-RNTI to receive the RRC configuration message during the running period of the first timer. For the case where the contention resolution information and the RRC configuration message are transmitted in different TBs, the PDCCH may be monitored at the appropriate time to receive the RRC configuration message sent separately, and there is no need to continuously monitor the PDCCH after receiving the contention resolution information, thereby reducing unnecessary energy overhead of the terminal device and facilitating energy saving of the terminal device.

FIG. 14 is a fourth schematic diagram of receiving a Msg4 according to some embodiments of the present disclosure. As shown in FIG. 14, an example is illustrated, in which the configuration information includes the effective moment of the second starting moment offset and the configuration information of the first timer.

The terminal device receives the configuration information from the network device, and can obtain the effective moment of the second starting moment offset and the configuration information of the first timer according to the configuration information. Manners of obtaining the configuration information may include a dedicated signaling, system messages (such as MIB, SIB1, SIB2, SIB3, SIB4, etc.) sent in the broadcast manner, etc. For example, the network device sends the first system message to the terminal device, and the first system message includes the configuration information. The terminal device can obtain the first system message from the network device and obtains the configuration information according to the first system message. The network device sends the first RRC signaling to the terminal device, and the first RRC signaling includes the configuration information. The terminal device can obtain the first RRC signaling from the network device and obtains the configuration information according to the first RRC signaling.

FIG. 14 illustrates that the effective moment of the second starting moment offset is determined to be the moment at which the contention resolution information is received according to the configuration information, and the second starting moment offset is configured to delay starting the first timer. In some embodiments, the configuration information of the first timer may include the first duration or may not include the first duration. In response to the configuration information of the first timer including the first duration, the duration of the first timer is the first duration. In response to the configuration information of the first timer not including the first duration, the duration of the first timer is the duration of the contention resolution timer by default.

The terminal device can receive the second information from the network device, the second information includes the ephemeris information of the satellite associated with the terminal device and/or the third RTT from the DU to the CU. The first RTT from the terminal device to the CU and/or the second RTT from the terminal device to the DU is obtained according to the second information and/or the location information of the terminal device. In some embodiments, the network device can send the second system message to the terminal device, and the second system message includes the second information. The terminal device receives the second system message from the network device and obtains the second information according to the second system message. In some embodiments, the network device can send the second RRC signaling to the terminal device, and the second RRC signaling includes the second information. The terminal device receives the second RRC signaling from the network device and obtains the second information according to the second RRC signaling.

After the second RTT is obtained, the first starting moment offset offset1 can be configured according to the second RTT. The first starting moment offset offset1 is the second RTT from the terminal device to the DU.

The terminal device starts the contention resolution timer after the first starting moment offset offset1 passes from the first symbol after the transmission of the Msg3 ends, and restarts the contention resolution timer at each HARQ retransmission.

In some embodiments, during the running period of the contention resolution timer, the terminal device may always monitor the PDCCH to obtain the second transmission block without considering possible measurement intervals. The second transmission block includes the contention resolution information, so as to realize the reception of the contention resolution information.

During the running period of the contention resolution timer, if a notification of PDCCH transmission of a SpCell is received from a lower layer, it may be further known whether it is a contention resolution success.

In some embodiments, if the Msg3 includes the C-RNTI MAC CE, the contention resolution information uses the PDCCH scheduling scrambled by the C-RNTI. If the terminal device receives the PDCCH scheduling scrambled by the C-RNTI and the corresponding PDSCH, it indicates the contention resolution success.

In some embodiments, if the Msg3 does not include the C-RNTI but include the CCCH SDU, the contention resolution information uses the PDCCH scheduling scrambled by the TC-RNTI. When the MAC PDU is successfully decoded, the contention resolution timer is stopped. When the terminal device receives the PDSCH of the contention resolution information and determines the contention resolution success by matching a terminal device contention resolution identifier MAC CE in the contention resolution information with the CCCH SDU in the Msg3, it indicates the contention resolution success.

In response to the contention resolution timer being time out, the TC-RNTI is discarded, which indicates contention resolution unsuccess.

In some embodiments, after obtaining the first RTT, the terminal device configures the second starting moment offset offset2 according to the first RTT and the effective moment of the second starting moment offset. As shown in FIG. 14, the offset2 is a sum of a difference between the third RTT and the duration of the contention resolution timer and a current remaining duration of the contention resolution timer. That is, offset2=third RTT−duration of the contention resolution timer+current remaining duration of the contention resolution timer. If the contention resolution timer starts at moment t1, the duration of the contention resolution timer is T, and the terminal device receives the contention resolution information at moment t2, the current remaining duration of the contention resolution timer is T−(t2−t1).

In some embodiments, the network device may indicate the second starting moment offset (such as length of the offset2) in the Msg2 or the contention resolution information through the MAC CE. The network device sends the MAC CE to the terminal device, and the terminal device obtains the second starting moment offset according to the MAC CE. That is, the second starting moment offset is a duration indicated by the MAC CE. The MAC CE may be carried in the Msg2 and may also be carried in the contention resolution information.

The terminal device determines whether to start the first timer after receiving the contention resolution information.

When it is the contention resolution success and the contention resolution information includes the RRC configuration message, the terminal device does not start the first timer.

When it is the contention resolution success and the contention resolution information does not include the RRC configuration message, the terminal device starts the first timer after the second starting moment offset passes from the moment at which the contention resolution information is received. During the running period of the first timer, the terminal device monitors the PDCCH and obtains the RRC configuration message. The duration of monitoring the PDCCH is less than or equal to the duration of the first timer.

In some embodiments, during the running period of the first timer, the terminal device may always monitor the PDCCH without considering possible measurement intervals.

During the running period of the first timer, if the notification of PDCCH transmission of the SpCell is received from the lower layer and the PDSCH scheduled by the PDCCH includes the RRC configuration message, the RRC configuration message is delivered to the upper layer and the first timer is stopped. In this case, it is considered that the terminal device successfully receives the RRC configuration message.

Failure of receiving the RRC configuration message is reported to the upper layer in response to the first timer being time out. In this case, it is considered that the terminal device fails to receive the RRC configuration message.

In embodiments of the present disclosure, the terminal device further adds the first timer configured to receive the RRC configuration message sent separately in addition to starting the contention resolution timer, and configures the first starting moment offset for delaying starting the contention resolution timer and the second starting moment offset for delaying starting the first timer. The effective moment of the second starting moment offset is the moment at which the contention resolution information received. The PDCCH is monitored to receive the contention resolution information during the running period of the contention resolution timer, and the terminal device continuously monitors the PDCCH scrambled by the C-RNTI to receive the RRC configuration message during the running period of the first timer. For the case where the contention resolution information and the RRC configuration message are transmitted in different TBs, the PDCCH may be monitored at the appropriate time to receive the RRC configuration message sent separately, and there is no need to continuously monitor the PDCCH after receiving the contention resolution information, thereby reducing unnecessary energy overhead of the terminal device and facilitating energy saving of the terminal device.

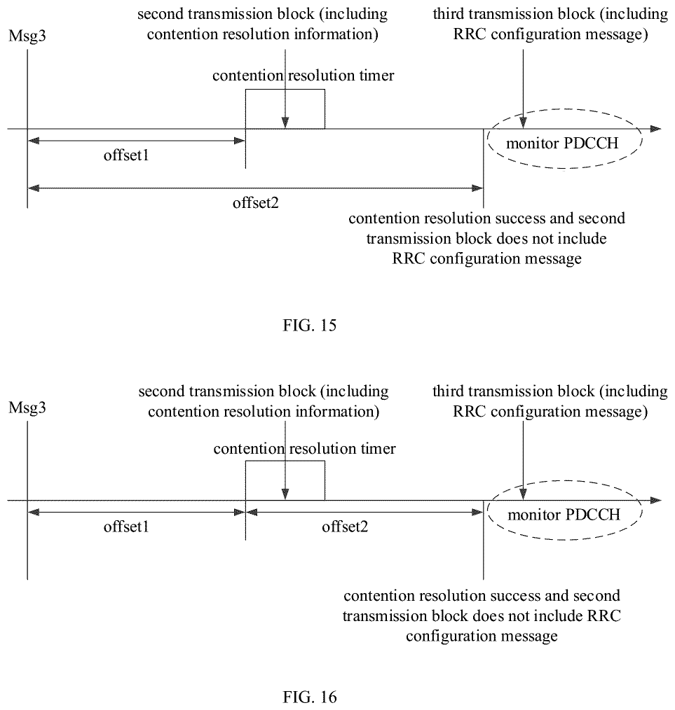

FIG. 12 to FIG. 14 illustrate schemes in which the terminal device receives the Msg4 when the configuration information includes the effective moment and the configuration information of the first timer. A scheme in which the configuration information includes the effective moment will be described below in conjunction with FIG. 15 to FIG. 17.

FIG. 15 is a fifth schematic diagram of receiving a Msg4 according to some embodiments of the present disclosure. As shown in FIG. 15, an example is illustrated, in which the configuration information includes the effective moment of the second starting moment offset.

The terminal device receives the configuration information from the network device, and may obtain the effective moment of the second starting moment offset according to the configuration information. Manners of obtaining the configuration information may include dedicated signaling, system messages (such as MIB, SIB1, SIB2, SIB3, SIB4, etc.) sent in the broadcast manner, etc. For example, the network device sends the first system message to the terminal device, and the first system message includes the configuration information. The terminal device can obtain the first system message from the network device and obtains the configuration information according to the first system message. The network device sends the first RRC signaling to the terminal device, and the first RRC signaling includes the configuration information. The terminal device can obtain the first RRC signaling from the network device and obtains the configuration information according to the first RRC signaling.

The terminal device can receive the second information from the network device, the second information includes the ephemeris information of the satellite associated with the terminal device and/or the third RTT from the DU to the CU. The first RTT from the terminal device to the CU and/or the second RTT from the terminal device to the DU is obtained according to the second information and/or the location information of the terminal device. In some embodiments, the network device can send the second system message to the terminal device, and the second system message includes the second information. The terminal device receives the second system message from the network device and obtains the second information according to the second system message. In some embodiments, the network device can send the second RRC signaling to the terminal device, and the second RRC signaling includes the second information. The terminal device receives the second RRC signaling from the network device and obtains the second information according to the second RRC signaling.

After the second RTT is obtained, the first starting moment offset offset1 can be configured according to the second RTT. The first starting moment offset offset1 is the second RTT from the terminal device to the DU.

The terminal device starts the contention resolution timer after the first starting moment offset offset1 passes from the first symbol after the transmission of the Msg3 ends, and restarts the contention resolution timer at each HARQ retransmission.

In some embodiments, during the running period of the contention resolution timer, without considering possible measurement intervals, the terminal device may always monitor the PDCCH to obtain the second transmission block. The second transmission block includes the contention resolution information, so as to realize the reception of the contention resolution information.

During the running period of the contention resolution timer, if a notification of PDCCH transmission of a SpCell is received from a lower layer, it may be further known whether it is a contention resolution success.

In some embodiments, if the Msg3 includes the C-RNTI MAC CE, the contention resolution information uses the PDCCH scheduling scrambled by the C-RNTI. If the terminal device receives the PDCCH scheduling scrambled by the C-RNTI and the corresponding PDSCH, it indicates the contention resolution success.

In some embodiments, if the Msg3 does not include the C-RNTI but include the CCCH SDU, the contention resolution information uses the PDCCH scheduling scrambled by the TC-RNTI. When the MAC PDU is successfully decoded, the contention resolution timer is stopped. When the terminal device receives the PDSCH of the contention resolution information and determines the contention resolution success by matching a terminal device contention resolution identifier MAC CE in the contention resolution information with the CCCH SDU in the Msg3, it indicates the contention resolution success.

In response to the contention resolution timer being time out, the TC-RNTI is discarded, which indicates contention resolution unsuccess.

FIG. 15 illustrates that the effective moment of the second starting moment offset is determined to be the moment at which the transmission of the Msg3 ends. After obtaining the first RTT, the terminal device configures the second starting moment offset offset2 according to the first RTT and the effective moment of the second starting moment offset. As shown in FIG. 15, the offset2 is the first RTT.

The terminal device determines to start to continuously monitor the PDCCH to obtain the RRC configuration message when the contention resolution successes and the second transmission block does not include the RRC configuration message after the second starting moment offset offset2 passes from the first symbol after the transmission of the Msg3 ends. When the terminal device receives the RRC configuration message, monitoring the PDCCH may be stopped.

In regenerative payload scenario of the gNB-DU carried in the satellite, when the terminal device performs the random access procedure, different first starting moment offsets for delaying starting the contention resolution timer configured according to the events triggering a random access procedure in schemes of the present disclosure. Since the functions of the MAC layer are terminated on the gNB-DU carried in the satellite, the functions of the RRC layer are terminated on the gNB-CU located on the ground, there is the feeder link offset between the MAC layer and the RRC layer, there is even the one-hop or the multi-hop inter-satellite link offset (in scenarios with the inter-satellite link). Therefore, there is an inevitable time difference between generation of the Msg4 and generation of the RRC configuration message. In embodiments of the present disclosure, in addition to starting the contention resolution timer, the terminal device further configures the second starting moment offset configured to indicate the appropriate time to start to continuously monitor the PDCCH scrambled by the C-RNTI to receive the RRC configuration message. The effective moment of the second starting moment offset is the moment at which the transmission of the Msg3 ends. By setting the second starting moment offset, there is no need to continuously monitor the PDCCH after receiving the contention resolution information, but to monitor the PDCCH at the appropriate time to receive the RRC configuration message, thereby reducing unnecessary energy overhead of the terminal device and facilitating energy saving of the terminal device. Further, since there is no need to configure the first timer and set a length, timeout behavior, and stop condition of the first timer, signaling consumption is also reduced.

FIG. 16 is a sixth schematic diagram of receiving a Msg4 according to some embodiments of the present disclosure. As shown in FIG. 16, an example is illustrated, in which the configuration information includes the effective moment of the second starting moment offset.

The terminal device receives the configuration information from the network device, and may obtain the effective moment of the second starting moment offset according to the configuration information. Manners of obtaining the configuration information may include dedicated signaling, system messages (such as MIB, SIB1, SIB2, SIB3, SIB4, etc.) sent in the broadcast manner, etc. For example, the network device sends the first system message to the terminal device, and the first system message includes the configuration information. The terminal device can obtain the first system message from the network device and obtains the configuration information according to the first system message. The network device sends the first RRC signaling to the terminal device, and the first RRC signaling includes the configuration information. The terminal device can obtain the first RRC signaling from the network device and obtains the configuration information according to the first RRC signaling.

The terminal device can receive the second information from the network device, the second information includes the ephemeris information of the satellite associated with the terminal device and/or the third RTT from the DU to the CU. The first RTT from the terminal device to the CU and/or the second RTT from the terminal device to the DU is obtained according to the second information and/or the location information of the terminal device. In some embodiments, the network device can send the second system message to the terminal device, and the second system message includes the second information. The terminal device receives the second system message from the network device and obtains the second information according to the second system message. In some embodiments, the network device can send the second RRC signaling to the terminal device, and the second RRC signaling includes the second information. The terminal device receives the second RRC signaling from the network device and obtains the second information according to the second RRC signaling.

After the second RTT is obtained, the first starting moment offset offset1 can be configured according to the second RTT. The first starting moment offset offset1 is the second RTT from the terminal device to the DU.

The terminal device starts the contention resolution timer after the first starting moment offset offset1 passes from the first symbol after the transmission of the Msg3 ends, and restarts the contention resolution timer at each HARQ retransmission.

In some embodiments, during the running period of the contention resolution timer, the terminal device may always monitor the PDCCH to obtain the second transmission block without considering possible measurement intervals. The second transmission block includes the contention resolution information, so as to realize the reception of the contention resolution information.

During the running period of the contention resolution timer, if the notification of PDCCH transmission of a SpCell is received from the lower layer, it may be further known whether it is a contention resolution success.

In some embodiments, if the Msg3 includes the C-RNTI MAC CE, the contention resolution information uses the PDCCH scheduling scrambled by the C-RNTI. If the terminal device receives the PDCCH scheduling scrambled by the C-RNTI and the corresponding PDSCH, it indicates the contention resolution success.

In some embodiments, if the Msg3 does not include the C-RNTI but include the CCCH SDU, the contention resolution information uses the PDCCH scheduling scrambled by the TC-RNTI. When the MAC PDU is successfully decoded, the contention resolution timer is stopped. When the terminal device receives the PDSCH of the contention resolution information and determines the contention resolution success by matching a terminal device contention resolution identifier MAC CE in the contention resolution information with the CCCH SDU in the Msg3, it indicates the contention resolution success.

In response to the contention resolution timer being time out, the TC-RNTI is discarded, which indicates contention resolution unsuccess.

FIG. 16 illustrates that the effective moment of the second starting moment offset is determined to be the moment at which the contention resolution timer starts. After obtaining the first RTT, the terminal device configures the second starting moment offset offset2 according to the first RTT and the effective moment of the second starting moment offset. As shown in FIG. 16, the offset2 is the third RTT from the DU to the CU.

The terminal device determines to start to continuously monitor the PDCCH to obtain the RRC configuration message when the contention resolution successes and the second transmission block does not include the RRC configuration message after the second starting moment offset offset2 passes from which the contention resolution timer starts. When the terminal device receives the RRC configuration message, monitoring the PDCCH may be stopped.

In embodiments of the present disclosure, in addition to starting the contention resolution timer, the terminal device further configured the second starting moment offset configured to indicate the appropriate time to start to continuously monitor the PDCCH scrambled by the C-RNTI to receive the RRC configuration message. The effective moment of the second starting moment offset is the moment at which the contention resolution timer starts. By setting the second starting moment offset, there is no need to continuously monitor the PDCCH after receiving the contention resolution information, but to monitor the PDCCH at the appropriate time to receive the RRC configuration message, thereby reducing unnecessary energy overhead of the terminal device and facilitating energy saving of the terminal device. Further, since there is no need to configure the first timer and set a length, timeout behavior, and stop condition of the first timer, signaling consumption is also reduced.

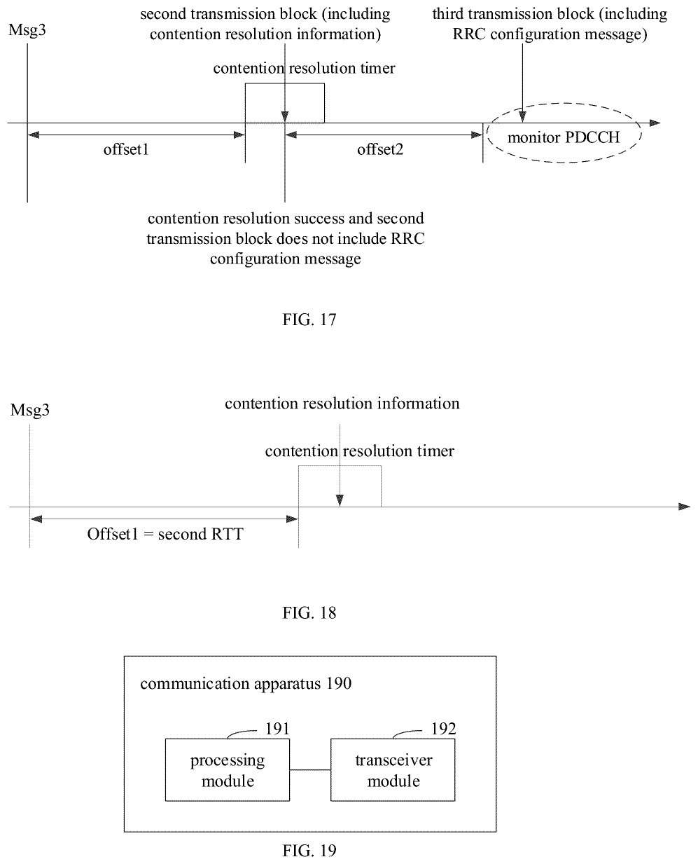

FIG. 17 is a seventh schematic diagram of receiving a Msg4 according to some embodiments of the present disclosure. As shown in FIG. 17, an example is illustrated, in which the configuration information includes the effective moment of the second starting moment offset.

The terminal device receives the configuration information from the network device, and may obtain the effective moment of the second starting moment offset according to the configuration information. Manners of obtaining the configuration information may include dedicated signaling, system messages (such as MIB, SIB1, SIB2, SIB3, SIB4, etc.) sent in the broadcast manner, etc. For example, the network device sends the first system message to the terminal device, and the first system message includes the configuration information. The terminal device can obtain the first system message from the network device and obtains the configuration information according to the first system message. The network device sends the first RRC signaling to the terminal device, and the first RRC signaling includes the configuration information. The terminal device can obtain the first RRC signaling from the network device and obtains the configuration information according to the first RRC signaling.

The terminal device can receive the second information from the network device, the second information includes the ephemeris information of the satellite associated with the terminal device and/or the third RTT from the DU to the CU. The first RTT from the terminal device to the CU and/or the second RTT from the terminal device to the DU is obtained according to the second information and/or the location information of the terminal device. In some embodiments, the network device can send the second system message to the terminal device, and the second system message includes the second information. The terminal device receives the second system message from the network device and obtains the second information according to the second system message. In some embodiments, the network device can send the second RRC signaling to the terminal device, and the second RRC signaling includes the second information. The terminal device receives the second RRC signaling from the network device and obtains the second information according to the second RRC signaling.

After the second RTT is obtained, the first starting moment offset offset1 can be configured according to the second RTT. The first starting moment offset offset1 is the second RTT from the terminal device to the DU.

The terminal device starts the contention resolution timer after the first starting moment offset offset1 passes from the first symbol after the transmission of the Msg3 ends, and restarts the contention resolution timer at each HARQ retransmission.

In some embodiments, during the running period of the contention resolution timer, the terminal device may always monitor the PDCCH to obtain the second transmission block without considering possible measurement intervals. The second transmission block includes the contention resolution information, so as to realize the reception of the contention resolution information.

During the running period of the contention resolution timer, if the notification of PDCCH transmission of a SpCell is received from the lower layer, it may be further known whether it is a contention resolution success.

In some embodiments, if the Msg3 includes the C-RNTI MAC CE, the contention resolution information uses the PDCCH scheduling scrambled by the C-RNTI. If the terminal device receives the PDCCH scheduling scrambled by the C-RNTI and the corresponding PDSCH, it indicates the contention resolution success.

In some embodiments, if the Msg3 does not include the C-RNTI but include the CCCH SDU, the contention resolution information uses the PDCCH scheduling scrambled by the TC-RNTI. When the MAC PDU is successfully decoded, the contention resolution timer is stopped. When the terminal device receives the PDSCH of the contention resolution information and determines the contention resolution success by matching a terminal device contention resolution identifier MAC CE in the contention resolution information with the CCCH SDU in the Msg3, it indicates the contention resolution success.

In response to the contention resolution timer being time out, the TC-RNTI is discarded, which indicates contention resolution unsuccess.

FIG. 17 illustrates that the effective moment of the second starting moment offset is determined to be the moment at which the contention resolution information is received according to the configuration information. In some embodiments, after obtaining the first RTT, the terminal device configures the second starting moment offset offset2 according to the first RTT and the effective moment of the second starting moment offset. As shown in FIG. 17, the offset2 is a sum of a difference between the third RTT and a duration of the contention resolution timer and a current remaining duration of the contention resolution timer. That is, offset2=third RTT−duration of the contention resolution timer+current remaining duration of the contention resolution timer. If the contention resolution timer starts at moment t1, the duration of the contention resolution timer is T, and the terminal device receives the Msg4 at moment t2, the current remaining duration of the contention resolution timer is T−(t2−t1).

In some embodiments, the network device may indicate the second starting moment offset (i.e., a length of the offset2) in the Msg2 or the contention resolution information through the MAC CE. The network device sends the MAC CE to the terminal device, and the terminal device obtains the second starting moment offset according to the MAC CE. That is, the second starting moment offset is a duration indicated by the MAC CE. The MAC CE may be carried in the Msg2 and may also be carried in the contention resolution information.

The terminal device starts to continuously monitor the PDCCH to obtain the RRC configuration message when the contention resolution successes and the second transmission block does not include the RRC configuration message after the second starting moment offset offset2 passes from which the contention resolution information is received. When the terminal device receives the RRC configuration message, monitoring the PDCCH may be stopped.

In embodiments of the present disclosure, in addition to starting the contention resolution timer, the terminal device further configured the second starting moment offset configured to indicate the appropriate time to start to continuously monitor the PDCCH scrambled by the C-RNTI to receive the RRC configuration message. The effective moment of the second starting moment offset is the moment at which the contention resolution information is received. By setting the second starting moment offset, there is no need to continuously monitor the PDCCH after receiving the contention resolution information, but to monitor the PDCCH at the appropriate time to receive the RRC configuration message, thereby reducing unnecessary energy overhead of the terminal device and facilitating energy saving of the terminal device. Further, since there is no need to configure the first timer and set a length, timeout behavior, and stop condition of the first timer, signaling consumption is also reduced.

In the above embodiments, schemes in which the terminal device receives the Msg4 when the Msg4 includes the contention resolution information and the RRC configuration message. When the event triggering the random access procedure is the second random access procedure event, the Msg4 is the contention resolution information. In this case, the starting moment offset is the first starting moment offset of the contention resolution timer and the first starting moment offset is the second RTT.

FIG. 18 is an eighth schematic diagram of receiving a Msg4 according to some embodiments of the present disclosure. As shown in FIG. 18, after the first starting moment offset passes from which the transmission of the Msg3 ends (that is the second RTT), the terminal device starts the contention resolution timer. During the running period of the contention resolution timer, the terminal device always monitors the PDCCH to obtain the contention resolution information without considering possible measurement intervals.

When the Msg4 does not include the RRC configuration message, the Msg4 is the contention resolution information. The contention resolution information is generated by the DU. Therefore, in embodiments of the present disclosure, the first starting moment offset is set according to the second RTT from the terminal device to the DU, and starting the contention resolution timer is delayed according to the first starting moment offset, realizing the reception of the message 4 in the regenerative payload scenario of the gNB-DU carried in the satellite.

FIG. 19 is a structural schematic view of a communication apparatus according to some embodiments of the present disclosure. As shown in FIG. 19, a communication apparatus 190 includes a processing module 191 and a transceiver module 192.

The processing module 191 is configured to determine a starting moment offset according to an event triggering a random access procedure, wherein the starting moment offset is configured to delay starting monitoring a PDCCH.

The transceiver module 192 is configured to receive a message 4 (Msg4) from a network device according to the starting moment offset, wherein the message 4 is contention resolution information, or the message 4 includes the contention resolution information and a RRC configuration message.

In some embodiments, the event triggering the random access procedure is a first random access procedure event or a second random access procedure event, the first random access procedure event is an event generating the RRC configuration message, and the second random access procedure event is other random access procedure event except for the first random access procedure event.

In some embodiments, the first random access procedure event includes one of: the terminal device triggering the random access procedure when the terminal device initially accesses, the terminal device triggering the random access procedure when the terminal device reestablishes a RRC connection, and the terminal device triggering the random access procedure when the terminal device restores the RRC. The second random access procedure event includes one of: the terminal device triggering the random access procedure when the terminal device establishes uplink synchronization with a new cell, the terminal device triggering the random access procedure when the terminal device is in a RRC connected state and there is no physical uplink control channel (PUCCH) resource for sending a scheduling request when uplink data arrives, the terminal device triggering the random access procedure when a scheduling request of the terminal device fails, the terminal device triggering the random access procedure when the terminal device requests a synchronization reconfiguration from RRC, the terminal device triggering the random access procedure when the terminal device establishes time synchronization in a process of adding a secondary cell, the terminal device triggering the random access procedure when the terminal device requests other system information, and the terminal device triggering the random access procedure when beams fail to be recovered.

In some embodiments, the message 4 includes the contention resolution information and the RRC configuration message in response to the event triggering the random access procedure being the first random access procedure event. The message 4 is the contention resolution information in response to the event triggering the random access procedure being the second random access procedure event. The starting moment offset includes a first RTT from the terminal device to a central unit (CU) and/or a second RTT from the terminal device to a distributed unit (DU), and the first RTT is equal to a sum of the second RTT and a third RTT from the DU to the CU.

In some embodiments, the message 4 includes the contention resolution information and the RRC configuration message. The processing module 191 is configured to determine the starting moment offset according to a transmission relationship between the contention resolution information and the RRC configuration message. The transmission relationship is the contention resolution information and the RRC configuration message being transmitted in a same transmission block, or the contention resolution information and the RRC configuration message being transmitted in different transmission blocks. The starting moment offset is a first starting moment offset of a contention resolution timer, or the starting moment offset includes the first starting moment offset and a second starting moment offset.

In some embodiments, the transmission relationship is the contention resolution information and the RRC configuration message being transmitted in the same transmission block, the starting moment offset is the first starting moment offset, and the first starting moment offset is the first RTT.

In some embodiments, the transceiver module 192 is configured to start the contention resolution timer after the first starting moment offset passes when transmission of a message 3 ends; and monitor the PDCCH and obtain a first transmission block during a running period of the contention resolution timer, wherein the first transmission block includes the contention resolution information and the RRC configuration message.

In some embodiments, the transmission relationship is the contention resolution information and the RRC configuration message being transmitted in different transmission blocks, and the starting moment offset includes the first starting moment offset and the second starting moment offset. The processing module 191 is configured to receive configuration information from the network device; and determine the starting moment offset according to the configuration information.

In some embodiments, the configuration information is configured by a system message or RRC signaling.

In some embodiments, the configuration information includes an effective moment of the second starting moment offset, or the configuration information includes the effective moment and configuration information of a first timer associated with the second starting moment offset.

In some embodiments, the first starting moment offset is the second RTT, and the second starting moment offset meets one of: the effective moment being a moment at which transmission of the message 3 ends, and the second starting moment offset being the first RTT; the effective moment being a moment at which the contention resolution timer starts, and the second starting moment offset being the third RTT; the effective moment being a moment at which the contention resolution information is received, and the second starting moment offset being a sum of a difference between the third RTT and a duration of the contention resolution timer and a current remaining duration of the contention resolution timer; and the effective moment being a moment at which the contention resolution information is received, and the second starting moment offset being a duration indicated by a medium access control element (MAC CE).

In some embodiments, the MAC CE is carried in a message 2 or in the contention resolution information.

In some embodiments, the transceiver module 192 is configured to start the contention resolution timer after the first starting moment offset passes from which transmission of a message 3 ends; monitor the PDCCH and obtain a second transmission block during the running period of the contention resolution timer, wherein the second transmission block includes the contention resolution information; and receive a third transmission block from the network device according to the effective moment and the second starting moment offset, wherein the third transmission block includes the RRC configuration message.

In some embodiments, the configuration information includes the effective moment and configuration information of the first timer; the transceiver module 192 is configured to start the first timer after the second starting moment offset passes from the effective moment; and monitor the PDCCH and obtain a third transmission block during a running period of the first timer, wherein a duration for monitoring the PDCCH is less than or equal to a duration of the first timer.

In some embodiments, the transceiver module 192 is configured to deliver the RRC configuration message to an upper layer, in response to a physical downlink shared channel (PDSCH) scheduled by the PDCCH including the RRC configuration message during the running period of the first timer; and report a failure of receiving the RRC configuration message to the upper layer, in response to the first timer being time out.

In some embodiments, the configuration information of the first timer includes a first duration, and a duration of the first timer is the first duration; or the configuration information of the first timer does not include the first duration, and a duration of the first timer is a duration of the contention resolution timer.

In some embodiments, the configuration information includes the effective moment; the transceiver module 192 is configured to monitor the PDCCH continuously and obtain the third transmission block after the second starting moment offset passes from the effective moment.

In some embodiments, the processing module 191 is further configured to determine a contention resolution success according to the contention resolution information. The second transmission block does not include the RRC configuration message. The contention resolution success includes one of: the message 3 including a MAC CE scrambled by a cell radio network temporary identifier (C-RNTI), and the terminal device receiving a PDCCH scrambled by the C-RNTI and a corresponding PDSCH; and the message 3 including a common control channel service data unit (CCCH SDU), and the terminal device determining the contention resolution success according to a contention resolution identifier MAC CE in the contention resolution information and the CCCH SDU.

In some embodiments, the message 4 is the contention resolution information, the starting moment offset is a first starting moment offset, and the first starting moment offset is the second RTT.

In some embodiments, the transceiver module 192 is configured to start the contention resolution timer after the first starting moment offset passes from which transmission of a message 3 ends; and monitor the PDCCH and obtain the contention resolution information during a running period of the contention resolution timer.

In some embodiments, the transceiver module 192 is configured to obtain first information from the network device; and determine the transmission relationship between the contention resolution information and the RRC configuration message according to the first information.

In some embodiments, the transceiver module 192 is configured to obtain second information from the network device, wherein the second information includes ephemeris information of a satellite associated with the terminal device and/or a third RTT from the DU to the CU; and obtain a first RTT from the terminal device to the CU and/or a second RTT from the terminal device to the DU, according to the second information and/or location information of the terminal device.

In some embodiments, the second information is configured by a system message or RRC signaling.

The embodiments of the present disclosure provide the communication apparatus, which may execute the technical solutions shown in method embodiments mentioned above, and the implementation principles and beneficial effects thereof are similar, and will not be described here again.

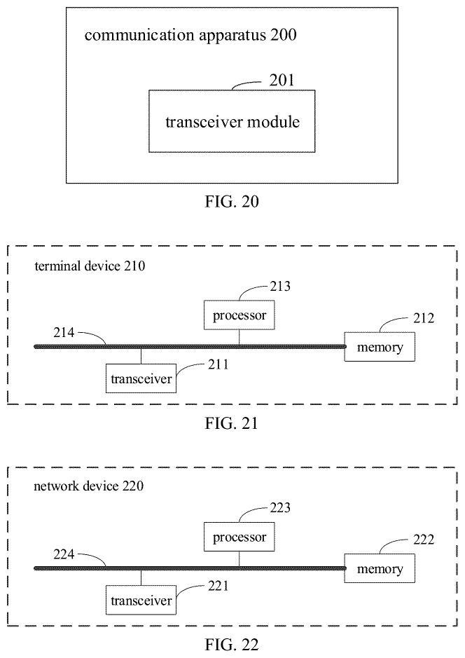

FIG. 20 is a structural schematic view of a communication apparatus according to some embodiments of the present disclosure. As shown in FIG. 20, a communication apparatus 200 includes a transceiver module 201 configured to send a message 4 (Msg4) to a terminal device according to an event triggering a random access procedure. The message 4 is contention resolution information, or the message 4 includes contention resolution information and a radio resource control (RRC) configuration message.

In some embodiments, the event triggering the random access procedure is a first random access procedure event or a second random access procedure event. The first random access procedure event is an event generating the RRC configuration message. The second random access procedure event is other random access procedure event except for the first random access procedure event.

In some embodiments, the first random access procedure event includes one of: the terminal device triggering the random access procedure when the terminal device initially accesses, the terminal device triggering the random access procedure when the terminal device reestablishes a RRC connection, and the terminal device triggering the random access procedure when the terminal device restores the RRC. The second random access procedure event includes one of: the terminal device triggering the random access procedure when the terminal device establishes uplink synchronization with a new cell, the terminal device triggering the random access procedure when the terminal device is in a RRC connected state and there is no physical uplink control channel (PUCCH) resource for sending a scheduling request when uplink data arrives, the terminal device triggering the random access procedure when a scheduling request of the terminal device fails, the terminal device triggering the random access procedure when the terminal device requests a synchronization reconfiguration from RRC, the terminal device triggering the random access procedure when the terminal device establishes time synchronization in a process of adding a secondary cell, the terminal device triggering the random access procedure when the terminal device requests other system information, and the terminal device triggering the random access procedure when beams fail to be recovered.

In some embodiments, the message 4 includes the contention resolution information and the RRC configuration message in response to the event triggering the random access procedure being the first random access procedure event. The message 4 is the contention resolution information in response to the event triggering the random access procedure being the second random access procedure event.

In some embodiments, the message 4 includes the contention resolution information and the RRC configuration message. The transceiver module 201 is configured to send the contention resolution information and the RRC configuration message to the terminal device according to a transmission relationship between the contention resolution information and the RRC configuration message. The transmission relationship is the contention resolution information and the RRC configuration message being transmitted in a same transmission block, or the contention resolution information and the RRC configuration message being transmitted in different transmission blocks.

In some embodiments, the transmission relationship is the contention resolution information and the RRC configuration message being transmitted in the same transmission block. The transceiver module 201 is configured to send a first transmission block to the terminal device. The first transmission block includes the contention resolution information and the RRC configuration message.

In some embodiments, the transmission relationship is the contention resolution information and the RRC configuration message being transmitted in different transmission blocks. The transceiver module 201 is configured to send a second transmission block and a third transmission block to the terminal device. The second transmission block includes the contention resolution information and the third transmission block includes the RRC configuration message.

In some embodiments, the transceiver module 201 is further configured to send configuration information to the terminal device.

In some embodiments, the configuration information is configured by a system message or RRC signaling.

In some embodiments, the configuration information includes an effective moment of a second starting moment offset, or the configuration information includes the effective moment and configuration information of a first timer associated with the second starting moment offset.

In some embodiments, the configuration information of the first timer includes a first duration or does not include the first duration.

In some embodiments, the transceiver module 201 is further configured to send a MAC CE to the terminal device. The MAC CE includes the second starting moment offset, and the effective moment of the second starting moment offset is a moment at which the terminal device receives the contention resolution information.

In some embodiments, the MAC CE is carried in a message 2 or in the contention resolution information.

In some embodiments, the message 4 is the contention resolution information; the transceiver module 201 is configured to send the contention resolution information to the terminal device.

In some embodiments, the transceiver module 201 is further configured to send first information to the terminal device. The first information is configured to indicate the transmission relationship between the contention resolution information and the RRC configuration message.

In some embodiments, the transceiver module 201 is configured to send second information to the terminal device. The second information includes ephemeris information of a satellite associated with the terminal device and/or a third RTT from a DU to a CU.

In some embodiments, the second information is configured by a system message or RRC signaling.

The embodiments of the present disclosure provide the communication apparatus, which may execute the technical solutions shown in method embodiments mentioned above, and the implementation principles and beneficial effects thereof are similar, and will not be described here again.

FIG. 21 is a structural schematic view of a terminal device according to some embodiments of the present disclosure. As shown in FIG. 21, the terminal device 210 may include a transceiver 211, a memory 212, and a processor 213. The transceiver 211 may include a transmitter and/or a receiver. The transmitter may also be referred to as a transmit port or a transmit interface, and the like. The receiver may also be referred to as a receive port or receive interface, and the like. Illustratively, the transceiver 211, the memory 212, and the processor 213 are interconnected by a bus 214.

The memory 212 is configured to store a computer executed instruction. The processor 213 is configured to perform the computer executed instruction stored in the memory, making the terminal device 210 to perform one of communication method described above. A receiver of the transceiver 211 may be configured to perform a receiving function of the terminal device in the communication method described above.

FIG. 22 is a structural schematic view of a network device according to some embodiments of the present disclosure. A s shown in FIG. 22, the network device 220 may include a transceiver 221, a memory 222, and a processor 223. The transceiver 221 may include a transmitter and/or a receiver. The transmitter may also be referred to as a transmit port or a transmit interface, and the like. The receiver may also be referred to as a receive port or receive interface, and the like. Illustratively, the transceiver 221, the memory 222, and the processor 223 are interconnected by a bus 224.

The memory 222 is configured to store a computer executed instruction. The processor 223 is configured to perform the computer executed instruction stored in the memory, making the terminal device 220 to perform one of communication method described above. A receiver of the transceiver 221 may be configured to perform a receiving function of the terminal device in the communication method described above.

The present disclosure provides a computer-readable storage medium, configured to store a computer executed instruction. The computer executed instruction is performed by a processor to realize the communication method described above.

The present disclosure provides a computer-readable storage medium, configured to store a computer executed instruction. The computer executed instruction is performed by a processor to realize the communication method described above.

The present disclosure further provides a computer program product, and the computer program product may be performed by a processor. In response to the computer program product being performed, the communication method performed by the terminal device or the network device described above may be implemented.

The communication device, the computer-readable storage medium and the computer program product in embodiments of the present disclosure can performed the communication method performed by the terminal device and the network device, and specific implementation process and beneficial effects thereof are referred to above, and are not described here.

In embodiments of the present disclosure, it should be understood that the systems, apparatus, and methods disclosed may be implemented in other ways. For example, the apparatus embodiments described above are merely illustrative. For example, the division of the units is only a logical functional division, and there may be other division modes in actual implementation. For example, a plurality of units or components may be combined or integrated into another system, or some features may be ignored or not executed. In another aspect, coupling, direct coupling or communicative connection between each other shown or discussed may be indirect coupling or communicative connection through some interfaces, devices, or units, and may be in electrical, mechanical, or other forms.

The units described as separate elements may or may not be physically separate, and the elements shown as units may or may not be physical units, that is, the units or the elements may be located in one place or may be distributed over multiple network units. Some or all of the units may be selected according to actual needs to achieve the purpose of the solution in the embodiments. In addition, each functional unit in each embodiment of the present disclosure may be integrated in one processing unit, or each unit may exist physically independently, or two or more units may be integrated in one unit. The integrated unit can be realized in the form of hardware or software functional unit.

Those skilled in the art can understand that all or part of the steps for implementing the above method embodiments can be accomplished by hardware related to program instructions. The aforementioned computer program may be stored in a computer-readable storage medium. When the computer program is executed by the processor, the steps including the above method embodiments is implemented. The storage medium includes ROM, RAM, magnetic disk or optical disk and other media capable of storing program codes.

Finally, it should be noted that the embodiments described above are only used to illustrate the technical solutions of the present disclosure, and not to limit it. Although the present disclosure has been described in detail with reference to the embodiments described above, those skilled in the art should understand that the technical solutions described in the embodiments described above can still be modified, or some or all of the technical features thereof can be equivalently replaced. However, these modifications or substitutions do not cause the essence of the corresponding technical solutions to depart from the scope of the technical solutions in embodiments of the present disclosure.

What is claimed is:

1. A communication method, applied to a terminal device, comprising:
determining a starting moment offset according to an event triggering a random access procedure, wherein the starting moment offset is configured to delay starting monitoring a physical downlink control channel (PDCCH);
receiving a message 4 (Msg 4) from a network device according to the starting moment offset, wherein the message 4 is contention resolution information, or the message 4 comprises the contention resolution information and a radio resource control (RRC) configuration message.

2. The method according to claim 1, wherein the event triggering the random access procedure is a first random access procedure event or a second random access procedure event,
the first random access procedure event is an event generating the RRC configuration message;
the second random access procedure event is other random access procedure event except for the first random access procedure event.

3. The method according to claim 2, wherein the message 4 comprises the contention resolution information and the RRC configuration message in response to the event triggering the random access procedure being the first random access procedure event;
the message 4 is the contention resolution information in response to the event triggering the random access procedure being the second random access procedure event;
the starting moment offset comprises a first round trip time (RTT) from the terminal device to a central unit (CU) and/or a second RTT from the terminal device to a distributed unit (DU), and the first RTT is equal to a sum of the second RTT and a third RTT from the DU to the CU.

4. The method according to claim 3, wherein the message 4 comprises the contention resolution information and the RRC configuration message;
the determining a starting moment offset according to an event triggering a random access procedure, comprises:
determining the starting moment offset according to a transmission relationship between the contention resolution information and the RRC configuration message;
wherein the transmission relationship is the contention resolution information and the RRC configuration message being transmitted in a same transmission block, or the contention resolution information and the RRC configuration message being transmitted in different transmission blocks;
the starting moment offset is a first starting moment offset of a contention resolution timer, or the starting moment offset comprises a second starting moment offset and a third starting moment offset.

5. A terminal device, comprising:
a transceiver;
a memory, configured to store a computer executed instruction; and
a processor, configured to perform the computer executed instruction stored in the memory, making the processor to perform:
determining a starting moment offset according to an event triggering a random access procedure, wherein the starting moment offset is configured to delay starting monitoring a physical downlink control channel (PDCCH);
receiving a message 4 (Msg 4) from a network device according to the starting moment offset, wherein the message 4 is contention resolution information, or the message 4 comprises the contention resolution information and a radio resource control (RRC) configuration message.

6. The terminal device according to claim 5, wherein the event triggering the random access procedure is a first random access procedure event or a second random access procedure event,
the first random access procedure event is an event generating the RRC configuration message;
the second random access procedure event is other random access procedure event except for the first random access procedure event.

7. The terminal device according to claim 6, wherein the message 4 comprises the contention resolution information and the RRC configuration message in response to the event triggering the random access procedure being the first random access procedure event;
the message 4 is the contention resolution information in response to the event triggering the random access procedure being the second random access procedure event;
the starting moment offset comprises a first round trip time (RTT) from the terminal device to a central unit (CU) and/or a second RTT from the terminal device to a distributed unit (DU), and the first RTT is equal to a sum of the second RTT and a third RTT from the DU to the CU.

8. The terminal device according to claim 7, wherein the message 4 comprises the contention resolution information and the RRC configuration message;
the determining a starting moment offset according to an event triggering a random access procedure, comprises:
determining the starting moment offset according to a transmission relationship between the contention resolution information and the RRC configuration message;
wherein the transmission relationship is the contention resolution information and the RRC configuration message being transmitted in a same transmission block, or the contention resolution information and the RRC configuration message being transmitted in different transmission blocks;
the starting moment offset is a first starting moment offset of a contention resolution timer, or the starting moment offset comprises a second starting moment offset and a third starting moment offset.

9. The terminal device according to claim 8, wherein the transmission relationship is the contention resolution information and the RRC configuration message being transmitted in the same transmission block, and the starting moment offset is the first starting moment offset, wherein the first starting moment offset is the first RTT.

10. The terminal device according to claim 9, wherein the receiving a message 4 from a network device according to the starting moment offset, comprises:
starting the contention resolution timer after the first starting moment offset passes from which transmission of a message 3 ends;
monitoring the PDCCH and obtaining a first transmission block during a running period of the contention resolution timer, wherein the first transmission block comprises the contention resolution information and the RRC configuration message.

11. The terminal device according to claim 8, wherein the transmission relationship is the contention resolution information and the RRC configuration message being transmitted in different transmission blocks, and the starting moment offset comprises the first starting moment offset and the second starting moment offset;
the determining a starting moment offset according to an event triggering a random access procedure, comprises:
receiving configuration information from the network device;
determining the starting moment offset according to the configuration information.

12. The terminal device according to claim 11, wherein the configuration information comprises an effective moment of the second starting moment offset; or
the configuration information comprises the effective moment and configuration information of a first timer associated with the second starting moment offset.

13. The terminal device according to claim 12, wherein the first starting moment offset is the second RTT, and the second starting moment offset meets any one of:
the effective moment being a moment at which transmission of the message 3 ends, and the second starting moment offset being the first RTT;
the effective moment being a moment at which the contention resolution timer starts, and the second starting moment offset being the third RTT;
the effective moment being a moment at which the contention resolution information is received, and the second starting moment offset being a sum of a difference between the third RTT and a duration of the contention resolution timer and a current remaining duration of the contention resolution timer;
the effective moment being a moment at which the contention resolution information is received, and the second starting moment offset being a duration indicated by a medium access control element (MAC CE).

14. The terminal device according to claim 12, wherein the receiving a message 4 from a network device according to the starting moment offset, comprises:
starting the contention resolution timer after the first starting moment offset passes from which transmission of a message 3 ends;
monitoring the PDCCH and obtaining a second transmission block during a running period of the contention resolution timer, wherein the second transmission block comprises the contention resolution information;
receiving a third transmission block from the network device according to the effective moment and the second starting moment offset, wherein the third transmission block comprises the RRC configuration message.

15. The terminal device according to claim 14, wherein the configuration information comprises the effective moment and the configuration information of the first timer;
the receiving a third transmission block from the network device according to the effective moment and the second starting moment offset, comprises:
starting the first timer after the second starting moment offset passes from the effective moment;
monitoring the PDCCH and obtaining the third transmission block during a running period of the first timer, wherein a duration for monitoring the PDCCH is less than or equal to a duration of the first timer.

16. The terminal device according to claim 15, wherein the monitoring the PDCCH and obtaining the third transmission block during a running period of the first timer, comprises:
delivering the RRC configuration message to a upper layer, in response to a physical downlink shared channel (PDSCH) scheduled by the PDCCH comprising the RRC configuration message during the running period of the first timer;
reporting a failure of receiving the RRC configuration message to the upper layer, in response to the first timer timing out.

17. The terminal device according to claim 15, wherein the configuration information of the first timer comprises a first duration, and a duration of the first timer is the first duration; or,
the configuration information of the first timer does not comprise the first duration, and the duration of the first timer is a duration of the contention resolution timer.

18. The terminal device according to claim 14, wherein the configuration information comprises the effective moment;
the receiving a third transmission block from the network device according to the effective moment and the second starting moment offset, comprises:
monitoring the PDCCH continuously and obtaining the third transmission block after the second starting moment offset passes from the effective moment.

19. A network device, comprising:
a transceiver;
a memory, configured to store a computer executed instruction; and
a processor, configured to perform the computer executed instruction stored in the memory, making the processor to perform:
sending a message 4 (Msg4) to a terminal device according to an event triggering a random access procedure, wherein the message 4 is contention resolution information, or the message 4 comprises the contention resolution information and a radio resource control (RRC) configuration message.

20. The network device according to claim 19, wherein the event triggering the random access procedure is a first random access procedure event or a second random access procedure event,
the first random access procedure event is an event generating the RRC configuration message;
the second random access procedure event is other random access procedure event except for the first random access procedure event.
